(19) United States
(12) Patent Application Publication
(10) Pub. No.: US 2025/0350936 A1
(43) Pub. Date: Nov. 13, 2025

(54) METHOD AND APPARATUS FOR PERFORMING SECURITY UPDATE IN MOBILE WIRELESS COMMUNICATION SYSTEM

(71) Applicants: Soenghun KIM, Gyeonggi-do (KR); BLACKPIN INC., Seoul (KR)

(72) Inventor: Soenghun KIM, Gyeonggi-do (KR)

(21) Appl. No.: 19/200,774

(22) Filed: May 7, 2025

(30) Foreign Application Priority Data
May 7, 2024 (KR) 1020240059802

(51) Int. Cl. H04W 12/041; H04L 9/08; H04W 76/27

(52) U.S. Cl. CPC H04W 12/041; H04L 9/0891; H04W 76/27

(57) ABSTRACT

A method to enable efficient data transfer for cell switch in conjunction with LTM operation is provided. The method of the terminal includes receiving from a specific Medium Access Control (MAC) Control Element (CE), deriving a second key-derivation-key based on a specific first key-derivation-key, wherein the specific first key-derivation-key is determined based on the specific integer in the MAC CE, deriving a first encryption-key based on the second key-derivation-key, configuring a specific set of Packet Data Convergence Protocol (PDCP) entities with the first encryption-key and reestablishing the specific set of PDCP entities.

### CROSS-REFERENCE TO RELATED APPLICATION

This application claims priority to and the benefit of Korean Patent Application No. 10-2024-0059802, filed on May 7, 2024, the disclosure of which is hereby incorporated herein by reference in its entirety.

### BACKGROUND

### Technical Field

The present disclosure relates to performing security update for layer 2 synchronous reconfiguration in wireless mobile communication system.

### Related Art

To meet the increasing demand for wireless data traffic since the commercialization of 4th generation (4G communication systems), the 5th generation (5G system) is being developed. 5G system introduced millimeter wave (mmW) frequency bands (e.g., 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability. To facilitate introduction of various services, 5G communication system targets supporting higher data rate and smaller latency.

When the UE passes from the coverage area of one cell to another cell, at some point a serving cell change need to be performed. Currently serving cell change is triggered by L3 measurements and is done by RRC signalling triggered Reconfiguration with Synch for change of PCell and PSCell, as well as release add for SCells when applicable, all cases with complete L2 (and L1) resets, and involving more latency, more overhead and more interruption time than beam switch mobility.

To meet the strict service requirements for the future mobile communication system, new mobility mechanism with less interruption time is required.

### SUMMARY

Aspects of the present disclosure are to enable lower layer triggered mobility. The method includes receiving from a specific Medium Access Control (MAC) Control Element (CE), deriving a second key-derivation-key based on a specific first key-derivation-key, wherein the specific first key-derivation-key is determined based on the specific integer in the MAC CE, deriving a first encryption-key based on the second key-derivation-key, configuring a specific set of Packet Data Convergence Protocol (PDCP) entities with the first encryption-key and reestablishing the specific set of PDCP entities.

### BRIEF DESCRIPTION OF THE DRAWINGS

FIG. 1 is a diagram illustrating the architecture of a 5G system and a NG-RAN to which the disclosure may be applied.

FIG. 2 is a diagram illustrating an wireless protocol architecture in a 5G system to which the disclosure may be applied.

FIG. 3 is a diagram illustrating L1/L2 triggered mobility procedure.

FIG. 4 is a diagram illustrating asynchronous reconfiguration and synchronous reconfiguration.

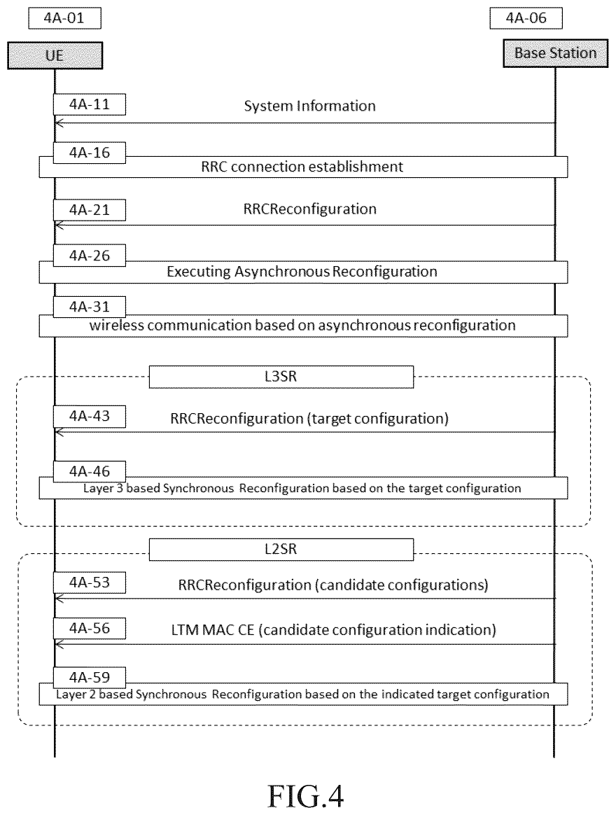

FIG. 5 is a diagram illustrating random access procedure for cell switch.

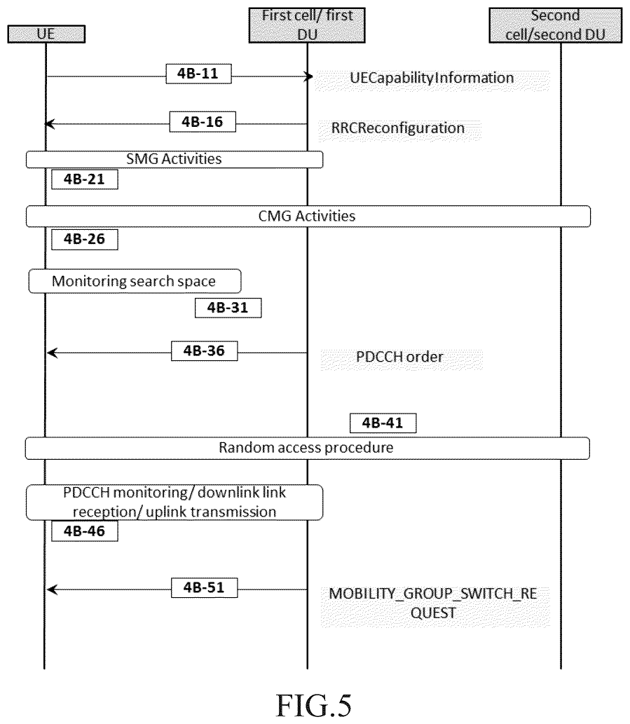

FIG. 6 is a diagram illustrating an example of mapping between SpCells and short identifiers.

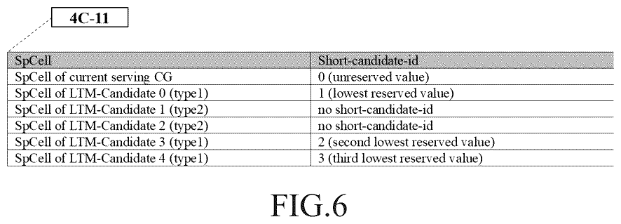

FIG. 7 is a diagram illustrating format of MAC CE for random access.

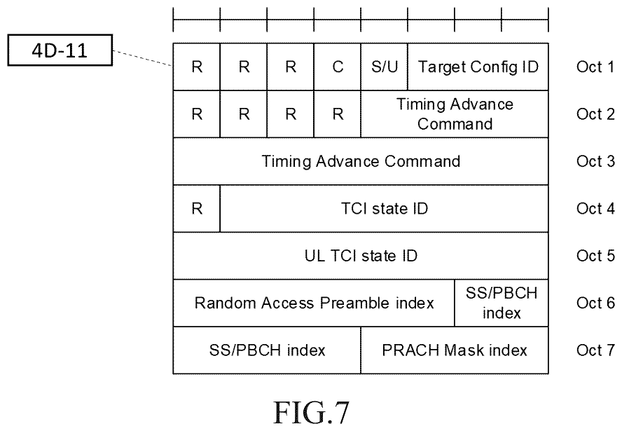

FIG. 8 is a diagram illustrating contention free random access related information.

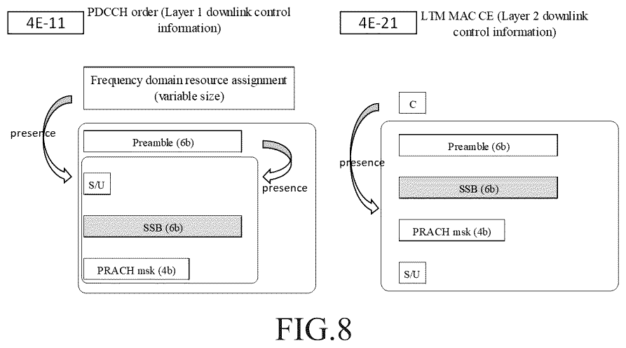

FIG. 9 is a diagram illustrating random access procedure based on downlink control information.

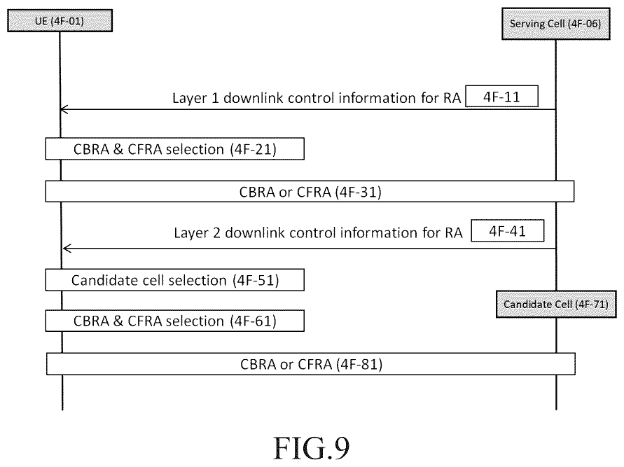

FIG. 10 is a diagram illustrating synchronous reconfiguration based on layer 2 downlink control message.

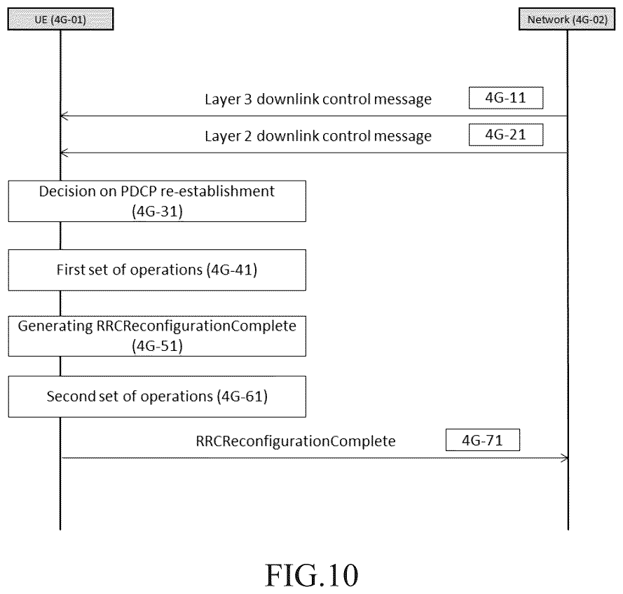

FIG. 11 is a flow diagram illustrating operation of a terminal for cell switch.

FIG. 12 is a block diagram illustrating the internal structure of a terminal.

FIG. 13 is a block diagram illustrating the configuration of a base station.

### DETAILED DESCRIPTION

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, followings are used interchangeably:
L2SR and LTM cell switch;
L3SR and handover;
SP CSI reporting on PUCCH Activation/Deactivation MAC CE and CSI report MAC CE;
LTM SP CSI reporting on PUCCH Activation/Deactivation MAC CE and LTM CSI report MAC CE;
P CSI and periodic CSI;
SP CSI and Semi persistent CSI;
UE and terminal;
GNB and base station;
L2 DCI and MAC CE;

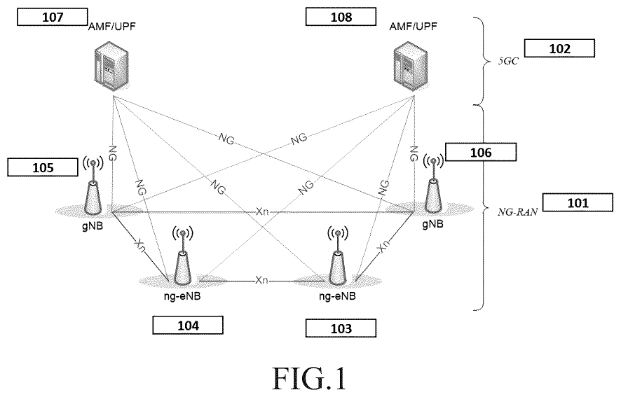

FIG. 1 is a diagram illustrating the architecture of a 5G system and a NG-RAN to which the disclosure may be applied.

5G system consists of NG-RAN 101 and 5GC 102. An NG-RAN node is either:
a GNB, providing NR user plane and control plane protocol terminations towards the UE; or
an ng-eNB, providing E-UTRA user plane and control plane protocol terminations towards the UE.

The GNBs 105 or 106 and ng-eNBs 103 or 104 are interconnected with each other by means of the Xn interface. The GNBs and ng-eNBs are also connected by means of the NG interfaces to the 5GC, more specifically to the AMF (Access and Mobility Management Function) and to the UPF (User Plane Function). AMF 107 and UPF 108 may be realized as a physical node or as separate physical nodes.

A GNB 105 or 106 or an ng-eNBs 103 or 104 hosts the functions listed below.

Functions for Radio Resource Management such as Radio Bearer Control, Radio Admission Control, Connection Mobility Control, Dynamic allocation of resources to UEs in uplink, downlink and sidelink (scheduling); and
IP and Ethernet header compression, uplink data decompression and encryption of user data stream; and
Selection of an AMF at UE attachment when no routing to an MME can be determined from the information provided by the UE; and
Routing of User Plane data towards UPF; and
Scheduling and transmission of paging messages; and
Scheduling and transmission of broadcast information (originated from the AMF or O&M); and
Measurement and measurement reporting configuration for mobility and scheduling; and
Session Management; and
QoS Flow management and mapping to data radio bearers; and
Support of UEs in RRC_INACTIVE state; and
Radio access network sharing; and
Tight interworking between NR and E-UTRA; and
Support of Network Slicing.

The AMF 107 hosts the functions such as NAS signaling, NAS signaling security, AS security control, SMF selection, Authentication, Mobility management and positioning management.

The UPF 108 hosts the functions such as packet routing and forwarding, transport level packet marking in the uplink, QoS handling and the downlink, mobility anchoring for mobility etc.

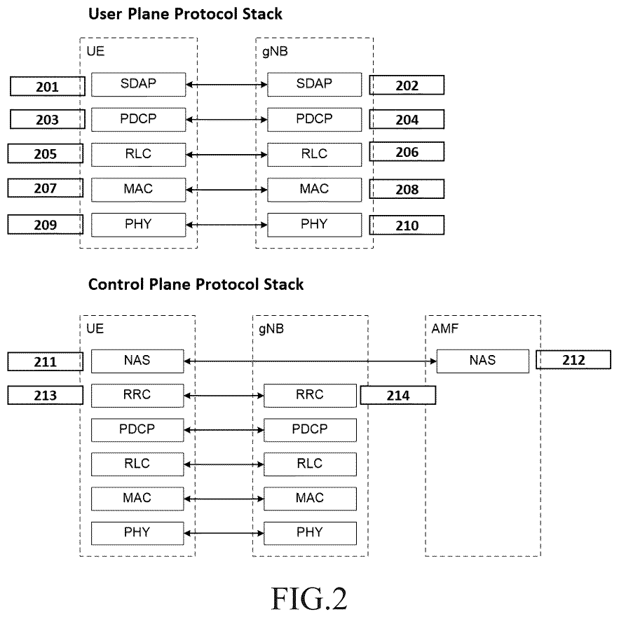

FIG. 2 is a diagram illustrating a wireless protocol architecture in a 5G system to which the disclosure may be applied.

User plane protocol stack consists of SDAP 201 or 202, PDCP 203 or 204, RLC 205 or 206, MAC 207 or 208 and PHY 209 or 210. Control plane protocol stack consists of NAS 211 or 212, RRC 213 or 214, PDCP, RLC, MAC and PHY.

Each protocol sublayer performs functions related to the operations listed below.

NAS: authentication, mobility management, security control etc.

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

Mobility is a key feature in mobile communications system. Conventional mobility feature relies on L3 measurements and L3 signaling, which may incur long delay and service interruption. To meet the strict service requirements for the future mobile communication system, L1/L2 Triggered Mobility (LTM) is introduced.

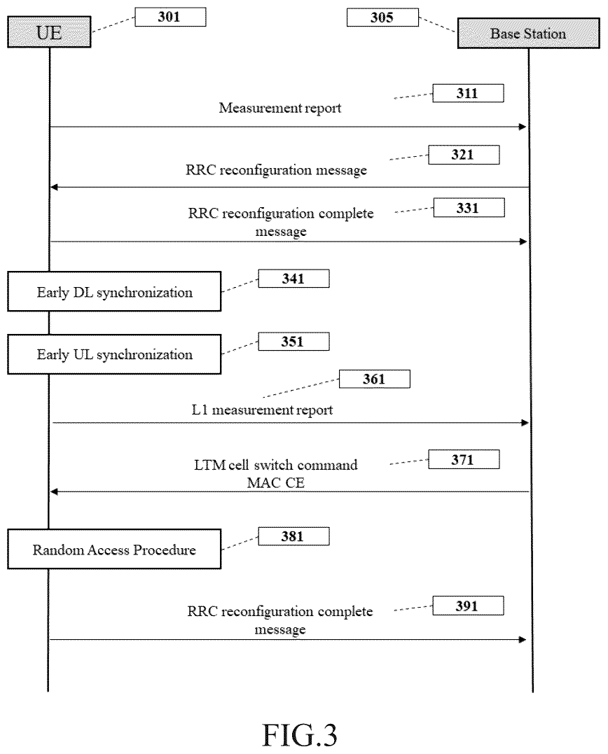

FIG. 3 illustrates the overall procedure for LTM.

LTM is a procedure in which a GNB receives L1 measurement report (e.g. LTM CSI report) from a UE, and on their basis the GNB changes UE serving cell by a cell switch command signalled via a MAC CE. The cell switch command indicates an LTM candidate configuration that the GNB previously prepared and provided to the UE through RRC signalling. Then the UE switches to the target configuration according to the cell switch command.

The UE sends a MeasurementReport message to the GNB. The GNB decides to configure LTM and initiates LTM preparation 311.

The GNB transmits an RRCReconfiguration message to the UE including the LTM candidate configurations 321.

The UE stores the LTM candidate configurations and transmits an RRCReconfigurationComplete message to the GNB 331.

The UE performs early DL synchronization with the LTM candidate cell(s) before receiving the cell switch command 341. The UE may activate and deactivate TCI states of LTM candidate cell(s), as triggered by the GNB. For this operation, type 2 type 2 TCI state activation/deactivation MAC CE is used. Apart from the early DL synchronization with the LTM candidate cell, GNB may use type 1 TCI state activation/deactivation MAC CE to active TCI states of serving cells.

The UE may perform early UL synchronization with LTM candidate cell(s) 351 before receiving the cell switch command, by using UE-based TA measurement, if configured, and/or by transmitting a preamble towards the candidate cell, as triggered by the GNB. UE performs early TA acquisition with the candidate cell(s) as requested by the network before receiving the cell switch command.

The UE performs L1 measurements on the configured LTM candidate cell(s) and transmits L1 measurement reports (LTM CSI report) to the GNB 361.

The GNB decides to execute cell switch to a target cell and transmits an LTM cell switch command MAC CE 371 triggering cell switch by including a target configuration ID which indicates the index of the candidate configuration of the target cell, a beam indicated with a TCI state or beams indicated with DL and UL TCI states, and a timing advance command for the target cell. The UE switches to the target cell and applies the candidate configuration indicated by the target configuration ID.

The UE performs the random access procedure towards the target cell 381, if UE does not have valid TA of the target cell.

The UE completes the LTM cell switch procedure by sending RRCReconfigurationComplete message to target cell 391.

RRC reconfiguration procedure is used for mobility purpose, the procedure should be synchronous between the UE and the base station. In that sense, RRC reconfiguration for mobility purpose could be denoted as synchronous reconfiguration. When the reconfiguration for mobility is triggered by a layer 3 control message (e.g., RRC message), the reconfiguration is denoted as layer 3 triggered synchronous reconfiguration (L3SR) or as layer 3 triggered reconfiguration for mobility (e.g., L3RM). When the reconfiguration for mobility is triggered by a layer 2 control message (e.g., MAC CE), the reconfiguration is denoted as layer 2 triggered synchronous reconfiguration (L2SR) or as layer 2 triggered reconfiguration for mobility (e.g., L2RM).

The UE 4A-01 is camping on a cell which is controlled by a base station 4A-06.

At 4A-11, UE receives system information from the base station. The system information includes ServingCellConfigCommonSIB to be applied by the UE in the cell.

At 4A-16, UE performs RRC connection establishment procedure with a base station based on the parameters contained in the ServingCellConfigCommonSIB. UE and the base station establish SRB1 during the RRC connection establishment procedure. The cell becomes SpCell of the UE after RRC connection establishment procedure.

In the RRC connection establishment procedure, UE receives from the base station a RRCSetup. The RRCSetup includes ServingCellConfig to be applied by the UE in the CELL1. The RRRCSetup includes RadioBearerConfig for SRB1.

After SRB1 establishment, UE may report its capability to the base station. The base station may decide the configuration to be applied to the UE based on the UE capability and traffic load status and traffic requirement. UE may report in which frequency bands the UE supports L3SR. UE may report in which frequency bands UE supports L2SR.

RRC connection establishment procedure is performed along with random access procedure.

At 4A-21, The base station transmits a first RRCReconfiguration to the UE. The first RRCReconfiguration may include at least following IEs/fields:
ServingCellConfig (or one or more fields contained in the IE); this IE, if included, replaces ServingCellConfig (or one or more field contained in the IE) received in RRCSetup;
RadioBearerConfig; the UE and base station establishes SRB2 and SRB4 based on this IE; the UE and the base station establishes one or more DRBs based on this IE.

At 4A-26, UE and the base station perform/execute asynchronous reconfiguration procedure based on the configuration information included in the first RRCReconfiguration.

UE and base station determine to perform asynchronous reconfiguration procedure if the corresponding RRCReconfiguration does not include Reconfugration WithSync IE.

UE applies the configuration information in the first RRCReconfiguration at time_point_1 and the base station applies the configuration information at time_point_2. The time_point_1 is when UE decodes the configuration information. The time_point_2 is when the base station considers transmission of the RRCReconfiguration containing the configuration information is successful (e.g. when HARQ ACK for the RRCReconfiguration is received).

After completion of the asynchronous reconfiguration procedure, UE and the base station perform wireless communication based on the following configuration 4A-31:
ServingCellConfigCommonSIB (e.g. broadcasted common serving cell configuration) received in the SIB1 of the SpCell (if ServingCellConfigCommon is not provided in RRCSetup) or ServingCellConfigCommon (e.g. dedicatedly delivered common serving cell configuration) in RRCSetup (if ServingCellConfigCommon is provided in RRCSetup);
ServingCellConfig (e.g. dedicate serving cell configuration) received in the RRCSetup (if the first RRCReconfgiration does not include ServingCellConfig) or in the first RRCReconfiguration (if the first RRCReconfiguration includes ServingCellConfig);
RadioBearConfig (e.g. radio bearer configuration) received in the first RRCReconfiguration (for SRB2 and SRB4) or RadioBearerConfig received in the RRCSetup (SRB1);

UE performs following operation based on ServingCellConfigCommonSIB received in the SIB1 of the SpCell:
initial BWP determination based on downlinkConfigCommon and uplinkConfigCommon;
contention based random access procedure in the initial BWP based on RACH-ConfigCommon (e.g. common RACH configuration);
uplink timing alignment based on n-TimingAdvanceOffset;

UE performs following operations based on ServingCellConfig received in the RRCSetup or in the first RRCReconfiguration:
BWP switching based on one or more BWP configuration information;
CSI reporting based on CSI-ReportConfig;
Scheduling Request based on SchedulingRequestReourceConfig;
SRS transmission based on SRS-Config;
TimeAlignmentTImer maintenance (e.g. setting the value of the timer) based on timeAlignmentTimer field for TAG 0

UE performs following operations based on RadioBearConfig received in the first RRCReconfiguration:
RRC message transmission and reception via SRB1 based on SRBToAddMod in RRCSetup;
RRC message transmission and reception via SRB2 and or SRB4 based on SRBToAddMod IEs in the first RRCReconfiguration;
IP packet transmission and reception via DRBs based on DRBToAddMod IEs in the first RRCReconfiguration.

To support UE mobility, the base station may determine to perform either L2SR or L3SR.

If the base station determines to apply L3SR, the base station and the UE perform 4A-43 and 4A-46.

If the base station determines to apply L2SR, the base station and the UE perform 4A-53 and 4A-56 and 4A-59.

For L3SR, the base station transmits to the UE a second RRCReconfiguration 4A-43.

The second RRCReconfiguration comprises ReconfigurationWithSync IE that contains common serving cell configuration for the target SpCell. The second RRCReconfiguration comprises various configurations such as RadioBeearConfig if the configurations are required to be updated.

The UE and the base station performs L3SR based on the target configuration contained in the second RRCReconfiguration 4A-46.

When the L3SR is triggered: UE performs configurations based on the target configurations contained in the second RRCReconfiguration; UE sets the contents of RRCReconfigurationComplete based on the contents of the second RRCReconfiguration; and UE transmits the RRCReconfigurationComplete in the target cell.

The configuration information such as Reconfiguration WithSync comprises various information for the target SpCell. The UE performs downlink synchronization for the target SpCell.

To transmit the RRCReconfigurationComplete, the UE initiates random access procedure in the target SpCell.

When the random access procedure triggered for RRCReconfigurationComplete is successfully completed, the UE and the base station consider the L3SR is successfully completed.

For L2SR, the base station transmits to the UE a third RRCReconfiguration 4A-53.

The third RRCReconfiguration comprises LTM-Config IE that contains a reference configuration and one or more candidate configurations.

The reference configuration comprises an embedded RRCReconfiguration.

Each candidate configuration comprises an embedded RRCReconfiguration. Each candidate configuration is associated with an identifier (e.g. candidateId).

The embedded RRCReconfiguration of each candidate configuration contains delta configuration over the embedded RRCReconfiguration of the reference configuration.

The UE generates a complete/target/final candidate configuration for a candidate by combining the embedded RRCReconfiugration of the candidate configuration with the embedded RRCReconfiguration of the reference configuration. More specifically, the UE determines IE X (of field x) of the candidate configuration is the IE X of the final candidate configuration in case that:
the IE X is present both in the candidate configuration and the reference configuration; or
the IE X is present only in the candidate configuration.

UE determines IE Y (or field y) of the reference configuration as the IE Y of the final candidate configuration in case that the IE Y is present only in the reference configuration.

Based on the layer 1 measurements (e.g. LTM CSI measurement and LTM CSI report), the base station may determine that cell switch is required for the UE.

The base station transmits UE LTM MAC CE 4A-56.

The UE and the base station perform L2SR based on the final candidate configuration indicated in the LTM MAC CE 4A-59.

When the L2SR is triggered: UE performs configurations based on the stored final configuration indicated the MAC CE; UE by sets the contents of RRCReconfigurationComplete based on the contents of the embedded RRCReconfiguration of the candidate configuration indicated by the MAC CE; and UE transmits the RRCReconfigurationComplete in the target SpCell of the candidate configuration.

The configuration information such as switch_info comprises various information for the target SpCell. The UE performs downlink synchronization for the target SpCell.

To transmit the RRCReconfigurationComplete, the UE may either initiate random access procedure in the target SpCell or monitor PDCCH to acquire uplink grant or use configured grant (if configured).

The UE and the base station consider the L2SR is successfully completed, when:
the random access procedure triggered for RRCReconfigurationComplete is successfully completed; or
uplink grant for new transmission is received after transmission of the RRCReconfigurationComplete.

The terminal is in a first cell. The first cell is controlled by a first DU. The first DU is controlled by a first CU. The first CU is connected with the first DU and a second DU. The first CU and the first DU and the second DU composes a base station. The second cell is controlled by the second DU.

In 4B-11, the terminal in the first cell transmits to the base station a RRC message for capability reporting. (UECapabilityInformation).

The UECapabilityInformation comprises following capability information.

One or more GroupL2mobility IEs. Each GroupL2mobility IE indicates whether the terminal supports MAC CE based mobility for a corresponding band. If the IE is included for the band, it indicates the terminal supports following functionality for the band.
Cell switch (mobility group switch) based on MOBILITY_GROUP_SWITCH_REQUEST MAC CE.
Transmission of MOBILITY_GROUP_SWITCH_RESPONSE after mobility group switch.
Second random access procedure.
Reception of second TAC MAC CE in SMG.
NTA maintenance after the second random access procedure.

In 4B-16, the terminal receives a RRC message containing configuration information for the terminal (RRCReconfiguration).

The RRCReconfiguration comprises a SMG configuration information and a list of CMG configuration information.

The SMG configuration information includes following IEs:
one or more layer1 parameter sets for a one or more serving cell (ServingCellConfigCommon and ServingCellConfig). Each of layer1 parameter set is applied to a specific serving cell;
Layer 2 parameter set (MAC-CellGroupConfig) applied to the one or more serving cells;
SpCell specific parameter set (reconfiguration WithSync). This parameter set is applied to a specific serving cell; and
Measurement configuration (MeasConfig). Measurement gap configuration (MeasGapConfig).

A CMG configuration information includes following IEs:
a CMG identifier; and
an inner RRCReconfiguration. The inner RRCReconfiguration includes the configuration information of the CMG; one or more ServingCellConfig, one or more ServingCellConfigCommon, a MAC-CellGroupConfig, a reconfiguration WithSync, a MeasConfig and a MeasGapConfig.

The MAC-CellGroupConfig includes one or more TAG configuration information such as TAT value and TAG identifier. Each serving cell is assigned with a TAG identifier.

The MAC-CellGroupConfig includes one or two DRX configuration (DRX-Config).

In 4B-21, the terminal performs SMG operation for serving cells of the SMG.

The terminal performs a SMG_Active_Operation for an active serving cells. Active serving cells comprise a SpCell and one or more active secondary cells.

### <SMG_Active_Operation>

UE monitors, based on the DRX configuration of the SMG and measurement gap configuration of the SMG, in the active downlink bandwidth parts of the active serving cells. UE monitors PDCCH during a first period.

UE receives, based on the measurement gap configuration of the SMG, PDSCH in the active downlink bandwidth parts of the active serving cells. UE receives PDSCH during a second period.

UE transmits, based on measurement gap configuration of the SMG, PUCCH for HARQ feedback and CSI report and SR in the active uplink bandwidth parts of one or two active serving cells. UE transmits PUCCH for HARQR feedback and CSI report and SR during a second period.

UE transmits, based on DRX configuration of the SMG and measurement gap configuration of the SMG, CSI on PUSCH in the active uplink bandwidth parts of one or more active serving cells. UE transmits CSI on PUSCH during a first period.

UE transmits, based on measurement gap configuration of the SMG and DRX configuration of the SMG, SRS in the active uplink bandwidth parts of one or more active serving cells. UE transmits SRS during a first period.

The first period is the period which is Active Time according to DRX configuration and not measurement gap according to measurement gap configuration.

The second period is the period which is not measurement gap according to measurement gap configuration.

In 4B-26, the terminal performs Candidate Mobility Group (CMG) operation for serving cells of the CMGs.

For each CMG, the terminal performs CMG_Preparation_Operaiton for a specific candidate cell. The specific candidate cell is the SpCell of the CMG. The specific candidate cell is candidate SpCell.

### <CMG_Preparation_Operaiton>

For each inner RRCReconfiguration included in the CMG list, the terminal performs followings.

The terminal performs downlink synchronization for the specific cell based on ssb-PositionsInBurst and absoluteFrequencySSB indicated in reconfiguration WithSync IE of the corresponding inner RRCReconfiguration.

The terminal measures SSBs based on ssb-PositionsInBurst and absoluteFrequencySSB indicated in reconfiguration WithSync IE of the corresponding inner RRCReconfiguration.

The terminal determines pathloss based on SSB measurement.

The terminal receives MIB based on ssb-PositionsInBurst and absoluteFrequencySSB indicated in reconfiguration WithSync IE of the corresponding inner RRCReconfiguration.

The terminal determines SFN of the candidate SpCell based on the received MIB.

In 4B-31, the terminal monitors one or more search spaces of the serving cells of SMG to receive PDCCH order.

The terminal monitors a first search space for a first PDCCH order. The terminal monitors a second search space for a second PDCCH order. The first search space and the second search space are configured in a reconfigurrationWithSync or in a one or more servingCellConfigCommon in SMG configuration. The first search space is for the first PDCCH order reception and for downlink scheduling and for uplink scheduling. The second search space is only for the second PDCCH order reception.

The first PDCCH order is transmitted to a terminal by the base station to trigger a first random access procedure of the terminal. The second PDCCH order is transmitted to a terminal by the base station to trigger a second random access procedure.

In 4B-36, the terminal receives a PDCCH order and performs random access procedure. The terminal performs the first RA procedure if the first PDCCH order is received. The terminal performs the second RA procedure if the second PDCCH order is received.

The first PDCCH order is transmitted by means of DCI format 1_0 with CRC scrambled by C-RNTI.

The first PDCCH order includes following information:
Frequency domain resource assignment field: This field is set to all ones;
Random Access Preamble index: This field indicates the preamble to be transmitted by the terminal; and
SS/PBCH index field: this field indicates the SS/PBCH that shall be used to determine the RACH occasion for the PRACH transmission.

The second PDCCH order is transmitted by means of DCI format 1_0 with CRC scrambled by EUA-RNTI.

The second PDCCH order includes following information:
Frequency domain resource assignment field: This field is set to a predefined value e.g. all zeros or all bits set to one but the last one set to zero;
Random Access Preamble index: This field indicates the preamble to be transmitted by the terminal;
SS/PBCH information: this field indicates one or more SS/PBCHs that shall be used to determine one or more RACH occasions for the PRACH transmission. This field could consist with two sub-fields. The first sub-field indicates the first SS/PBCH index and the second sub-field indicates the number of consecutive SS/PBHC indexes starting from the first SS/PBHC index. To keep the commonality between the first PDCCH order and the second PDCCH order, the first sub-field and the second sub-field are located in non-adjacent places. More specifically, the first sub-field locates immediately after Random Access Preamble index field and the second sub-field locates after CMG identifier field. Terminal determines the one or more RACH occasions based on the SS/PBCH information in the PDCCH order and ssb-perRACH-OccasionAndCB-PreamblesPerSSB in the reconfigurationWtihSync in the corresponding RRCReconfiguration. ssb-perRACH-OccasionAndCB-PreamblesPerSSB conveys the information about the number of SSBs per RACH occasion. Value oneEighth corresponds to one SSB associated with 8 RACH occasions, value oneFourth corresponds to one SSB associated with 4 RACH occasions and so on;
Second PDCCH order indicator field: If this field is set to a first value, the DCI format 1_0 is the second PDCCH order. If this field is set to a second value, the DCI format 1_0 is the first PDCCH order;
CMG identifier: This field conveys an identifier of the CMG. The terminal determines the candidate SpCell where preamble is to be transmitted based on this field. Alternatively, this field comprises an identifier (e.g., short-candidate-id) derived from the CMG identifier. CMG identifier and ltm-CandidateId are used interchangeably.
Preamble transmission power information: This field conveys information related to preamble transmission. This field indicates whether the preamble transmission power shall be ramped up comparing to the last preamble transmission in the same candidate SpCell or the transmission power shall be same as the last preamble transmission in the same candidate SpCell. This field can indicate power ramping shall be initialized to zero (ramping step is initialized to zero). Alternatively, this field indicates one of predefined power offset that shall be added to the preamble transmission power.

In 4B-41, the terminal performs random access procedure.

If the first PDCCH order is received, the terminal performs the first random access procedure. If the second PDCCH order is received, the terminal performs the second random access procedure.

The terminal performs the first random access procedure as follows:

The terminal sets PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP;

The terminal sets transmission power to the sum of PREAMBLE_RECEIVED_TARGET_POWER and pathloss of the serving cell where the first PDCCH order is received;

The terminal transmits the preamble in the RACH occasion determined from the SS/PBCH index field in the first PDCCH order. The terminal transmits the preamble in the active uplink bandwidth part of the serving cell where the first PDCCH order is received;

The terminal monitors PDCCH in a specific search space for a specific RNTI in a specific downlink bandwidth part of a specific serving cell. The specific serving cell is the serving cell where the preamble is transmitted. The specific downlink bandwidth part is the active downlink bandwidth part of the specific serving cell. The specific search space is indicated by ra-SearchSpace field in the configuration information of the specific serving cell. The specific RNTI is RA-RNTI. The terminal monitors PDCCH to receive a first random access response (RAR);

If the first RAR is not received, the terminal determines new transmission power based on new PREAMBLE_POWER_RAMPING_COUNTER and transmits the preamble with the new transmission new power. The PREAMBLE_POWER_RAMPING_COUNTER is the old PREAMBLE_POWER_RAMPING_COUNTER plus one.

The terminal performs the second random access procedure as follows:

The terminal sets PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP.

PREAMBLE_POWER_RAMPING_COUNTER is determined based on the Preamble transmission power information field in the second PDCCH order. Alternatively, the terminal sets PREAMBLE_RECEIVED_TARGET_POWER to preambleReceivedTargetPower+DELTA_PREAMBLE+POWER_OFFSET. POWER_OFFSET is determined based on the Preamble transmission power information field in the second PDCCH order;

The terminal sets transmission power to the sum of PREAMBLE_RECEIVED_TARGET_POWER and pathloss of a candidate SpCell. The candidate SpCell is determined based on CMG identifier field in the second PDCCH order and Reconfiguration WithSync IE in the corresponding inner RRCReconfiguration;

The terminal transmits the preamble in the one or more RACH occasions determined from the SS/PBCH information field in the second PDCCH order. The terminal transmits the preamble in the one or more RACH occasions with the same transmission power with different spatial domain transmission filters (different uplink beams). The terminal transmits the preamble in a specific uplink bandwidth part of a specific cell. The uplink bandwidth part identifier of the specific uplink bandwidth part is indicated in the reconfiguration WithSync IE of the inner RRCReconfiguration message corresponding to CMG identifier. The specific cell is the candidate SpCell;

The terminal monitors PDCCH in a specific search space for a specific RNTI in a specific downlink bandwidth part of a specific serving cell. The specific serving cell is the serving cell where the second PDCCH order is received. The downlink bandwidth part identifier of the specific downlink bandwidth part is indicated in the reconfiguration WithSync IE of the inner RRCReconfiguration message corresponding to CMG identifier. The specific search space is UE specific search space. The specific RNTI is C-RNTI of the SMG. The terminal monitors PDCCH to receive a second RAR.

The terminal receives a first RAR if the random access procedure was triggered by the first PDCCH order. The terminal receives a second RAR if the random access procedure was triggered by the second PDCCH order. One or more first RAR are included in a MAC PDU. The terminal determines the first RAR for itself based on MAC subhead associated with the first RAR. Only a single second RAR is included in a MAC PDU.

The first RAR comprises following information:
Timing Advance Command (TAC): The Timing Advance Command field indicates the index value TA used to control the amount of timing adjustment that the terminal has to apply for a specific TAG. The size of the Timing Advance Command field is 12 bits. The specific TAG is SMG TAG to which the serving cell belong. The serving cell is the cell where the first PDCCH order is received;
UL Grant: The Uplink Grant field indicates the resources to be used on the uplink. The size of the UL Grant field is 27 bits; This field includes TPC command for PUSCH (Msg 3). This field includes MCS for PUSCH. This field includes PUSCH time resource allocation for PUSCH;
Temporary C-RNTI: The Temporary C-RNTI field indicates the temporary identity that is used by the MAC entity during Random Access. The size of the Temporary C-RNTI field is 16 bits.

The second RAR comprises following information:
CMG identifier: This field indicates CMG to which a candidate cell belongs to. The candidate cell is the cell where the preamble was transmitted. The candidate cell is SpCell indicated in the inner RRCReconfiguration corresponding to the CMG identifier;
Timing Advance Command: The Timing Advance Command field indicates the index value TA used to control the amount of timing adjustment that the terminal has to apply for a specific TAG. The size of the Timing Advance Command field is 12 bit. The specific TAG is primary TAG of CMG indicated by CMG identifier;
UL beam index: This field indicates the index of the uplink beam that the terminal shall applied in a specific uplink bandwidth part of a specific cell. The UL beam index is in the form of SS/PBHC index. The specific uplink bandwidth part is indicated in the inner RRCReconfiguration corresponding to CMG identifier. The specific cell is the candidate SpCell indicated in the inner RRCReconfiguration corresponding to CMG identifier.

Upon receiving a RAR, the terminal adjusts uplink transmission timing of an uplink of a specific cell (or specific TAG) based on TAC in the RAR and based on a downlink frame boundary of a specific cell.

In case of the first random access procedure, followings apply:
The terminal determines TA of a specific serving TAG based on TA (TA=0, 1, 2, . . . , 3846) in the TAC field in the first RAR;
The terminal determines NTA of the specific serving TAG. NTA=TA*16*64/SCS_COEEFICIENT. SCS_COEEFICIENT is predefined per subcarrier spacing. SCS_COEFFICIENT is 1 if SCS is 15 KHz. SCS_COEFFICIENT is 2 if SCS is 30 KHz. SCS_COEFFICIENT is 4 if SCS is 60 KHz. SCS_COEFFICIENT is 8 if SCS is 120 KHz. SCS_COEFFICIENT is 16 if SCS is 240 KHz, and so on;
The terminal determines TTA of the specific serving TAG. TTA=(NTA+NTA_OFFSET)*T_C. NTA_OFFSET is indicated in SIB1. T_C is a basic time unit for NR. T_C is equal to 1/(480*1000*4096) ms;
The terminal applies TTA such that the terminal starts uplink frame boundary of the specific serving TAG TTA before the start of the corresponding downlink frame of any serving cell of the specific TAG;
The specific serving TAG is the TAG where a specific serving cell belongs to. The specific serving cell is the serving cell where the preamble is transmitted. SCS_COEFFICIENT is determined based on the SCS of the first PUSCH transmission after the reception of the first random access response.

In case of the second random access procedure, followings apply:
The terminal determines TA of a specific candidate TAG based on TA (TA=0, 1, 2, . . . , 3846) in the TAC field in the second RAR;
The terminal determines NTA of the specific candidate TAG. NTA=TA*16*64/SCS_COEEFICIENT;
The terminal determines TTA of the specific candidate TAG. TTA=(NTA+NTA_OFFSET)*T_C. NTA_OFFSET is indicated in the corresponding inner RRCReconfiguration;
The terminal applies TTA such that the terminal starts uplink frame boundary of the specific candidate TAG TTA before the start of the corresponding downlink frame of a specific candidate cell;
The specific candidate TAG is the TAG where a specific candidate cell belongs to. The terminal determines the specific candidate cell based on CMG identifier field of the second RAR. The specific candidate cell is the candidate SpCell of the CMG indicated by the CMG identifier field. SCS_COEFFICIENT is determined based on the SCS of the preamble transmission after the reception of the second PDCCH order.

After the reception of the RAR, UE starts or restarts a TimeAlignmentTimer.

If the first RAR is received, UE starts or restarts a TimeAlignmentTimer (TAT) of a specific serving TAG. The specific serving TAG is the TAG where a specific serving cell belongs to. The specific serving cell is the serving cell where the preamble is transmitted.

When the TAT of the serving TAG expires, the terminal performs followings.

The terminal flushes all HARQ buffer for all serving cells of the TAG.

The terminal releases SRS for all serving cells of the TAG.

The terminal releases PUCCH for all serving cells of the TAG.

The terminal clears any configured downlink assignment and configured uplink grants for all serving cells of the TAG.

The terminal does not perform any uplink transmission on a serving cell except the random access preamble when the TAT associated with the TAG to which the serving cell belongs is not running.

If the second RAR is received, UE starts or restarts a TAT of a specific candidate TAG. The specific candidate TAG is the TAG where a specific candidate cell belongs to. The terminal determines the specific candidate cell based on CMG identifier field of the second RAR.

When the TAT of the candidate TAG expires, the terminal performs followings:
The terminal flushes all HARQ buffer for all candidate cells of the TAG;
The terminal releases SRS for all candidate cells of the TAG. Before expiry of TAT, SRS re suspended. The suspended SRS of a candidate cell is activated when the candidate cell is switched to a serving cell;
The terminal releases PUCCH for all candidate cells of the TAG. Before expiry of TAT, PUCCH are suspended. The suspended PUCCH of a candidate cell is activated when the candidate cell is switched to a serving cell;
The terminal clears any configured downlink assignment and configured uplink grants for all candidate cells of the TAG. Before expiry of TAT, configured assignments and configured grants are suspended. The suspended configured assignment and the suspended configured grants of a candidate cell are activated when the candidate cell is switched to a serving cell;
The terminal releases the maintained/stored TTA and NTA of the candidate TAG.

The terminal does not perform any uplink transmission on a candidate cell except the random access preamble regardless of whether the TAT associated with the TAG to which the candidate cell belongs is running or not running.

TAT of SMG is to control uplink transmission and resource management (to release activated resource). TAG of CMG is to control NTA management and resource management (i.e. to release suspended resource)

In 4B-46, the terminal performs PDCCH monitoring and downlink reception and uplink transmission in the serving cells of SMG.

In 4B-51, the terminal receives a TAC MAC CE. If the first TAC MAC CE is received, the terminal (re) starts a TAT of the SMG. If the second TAC MAC CE is received, the terminal (re) starts a TAT of a CMG.

The first TAC MAC CE is identified by MAC subheader with a LCID. The first TAC MAC CE comprises following information:

TAG Identity (TAG ID): This field indicates the TAG Identity of the addressed TAG. The TAG containing the SpCell has the TAG Identity 0. The length of the field is 2 bits;

Timing Advance Command: This field indicates the index value TA (0, 1, 2 . . . 63) used to control the amount of timing adjustment that MAC entity has to apply The length of the field is 6 bits.

The terminal updates NTA of the serving TAG indicated by TAG ID field. The terminal adjusts uplink transmission of the serving TAG based on updated NTA.

The second TAC MAC CE is identified by MAC subheader with an eLCID. The second TAC MAC CE comprises following information:
CMG identifier: This field indicates CMG to which the TAG belongs;
TAG Identity (TAG ID): This field indicates the TAG Identity of the addressed TAG. The TAG containing the SpCell has the TAG Identity 0. The length of the field is 2 bits;
Timing Advance Command: This field indicates the index value TA (0, 1, 2 . . . 63) used to control the amount of timing adjustment that MAC entity has to apply The length of the field is 6 bits.

The terminal updates NTA of a specific TAG of a specific CMG. The specific CMG is indicated by CMG identifier field. The specific TAG is indicated by TAG Identity field.

The terminal maintains/stores the new NTA and the new TTA derived from the new NTA. The terminal (re) starts the TAT of the specific TAG of the specific CMG.

In 4B-51, the terminal receives from the base station a MOBILITY_GROUP_SWITCH_REQUEST MAC CE. The MOBILITY_GROUP_SWITCH_REQUEST MAC CE comprises a L2_RESET_INDICATOR field. If the field is set to a first value, UE performs L2_RESET_ACTIVITIES_1 for the MAC entity. If the field is set to a second value, UE performs L2_RESET_ACTIVITIES_2 for the MAC entity.

L2_RESET_ACTIVITIES_1 comprises following activities:

During L2_MOBILITY_PERIOD_1:
The terminal stops all TATs of all TAGs of the SMG;
The terminal stops ongoing Random Access procedure in SMG. The terminal continues ongoing Random Access procedure in CMG;
The terminal flush Msg3 buffer of SMG;
The terminal cancels triggered Scheduling Request procedure in SMG;
The terminal cancels triggered Buffer Status Reporting procedure in SMG;
The terminal cancels triggered Power Headroom Reporting procedure in SMG;
The terminal releases any configured uplink grants in SMG;
The terminal releases PUCCH in SMG;
The terminal releases SRS in SMG.

During L2_MOBILITY_PERIOD_3:
The terminal triggers Buffer Status Reporting procedure in CMG;
The terminal triggers Power Headroom Reporting procedure in CMG.

L2_RESET_ACTIVITIES_2 comprises following activities:

During L2_MOBILITY_PERIOD_1:
The terminal does not stop TATs of the SMG;
The terminal stops ongoing Random Access procedure in SMG. The terminal continues ongoing Random Access procedure in CMG;
The terminal cancels triggered Scheduling Request procedure in SMG;
The terminal cancels triggered Buffer Status Reporting procedure in SMG;
The terminal cancels triggered Power Headroom Reporting procedure in SMG;
The terminal suspends any configured uplink grants in SMG;
The terminal suspends PUCCH in SMG;
The terminal suspends SRS in SMG.

During L2_MOBILITY_PERIOD_3:
The terminal triggers Buffer Status Reporting procedure in CMG;
The terminal triggers Power Headroom Reporting procedure in CMG.

If the RAMDOM_ACCESS_REQUIRED_FIELD is set to a first value, UE performs RA_ACTIVITIES_1. If the field is set to a second value, UE performs RA_ACTIVITIES_2.

RA_ACTIVITIES_1 comprises following activities:
During L2_MOBILITY_PERIOD_1:
The terminal stops the TATs of the CMG;
The terminal clears configured grants in CMG;
The terminal releases suspended PUCCH in CMG;
The terminal releases suspended SRS in CMG.

During L2_MOBILITY_PERIOD_2:
The terminal triggers Random Access Procedure in the target candidate SpCell of the CMG;
The terminal generates MOBILITY_GROUP_SWITCH_RESPONSE MAC CE.

RA_ACTIVITIES_2 comprises following activities.

During L2_MOBILITY_PERIOD_1:
The terminal does not stop the TATs of the CMG;
The terminal does not clear configured grants in CMG.

During L2_MOBILITY_PERIOD_2:
The terminal applies maintained NTA and determines TTA for uplink transmission in the P-TAG of CMG;
The terminal monitor PDCCH with a specific C-RNTI in a specific downlink bandwidth part of the target candidate SpCell. The specific C-RNTI is the one indicated in a corresponding inner RRCReconfiguration. The specific downlink bandwidth part is the one indicated in the corresponding inner RRCReconfiguration;
The terminal activates suspended uplink grants of the CMG;
The terminal activates suspended PUCCH of the CMG;
The terminal activates suspended SRS of the CMG.

L2_MOBILITY_PERIOD_1 is from the moment when HARQ ACK for MOBILITY_GROUP_SWITCH_REQUEST is transmitted to the moment when the terminal switches to the CMG or candidate SpCell (i.e. terminal's transceiver is tuned to the CMG).

L2_MOBILITY_PERIOD_2 is from the moment when the terminal switches to the CMG/candidate SpCell to the moment when access to the target candidate SpCell is successfully completed.

L2_MOBILITY_PERIOD_3 is from the moment when access to the target candidate SpCell is successfully completed to the moment when HARQ ACK for MOBILITY_GROUP_SWITCH_RESPONSE is received.

Access to the target SpCell is considered successfully completed when uplink grant for new transmission addressed by the specific C-RNTI is received in the target SpCell.

Alternatively, access to the target SpCell is considered successfully completed when downlink assignment for new transmission addressed by the specific C-RNTI is received in the target SpCell.

Serving Mobility Group (SMG) and Default Mobility Group (DMG) are used interchangeably.

Additional Mobility Group (AMG) and Candidate Mobility Group (CMG) are used interchangeably.

SMG is equivalent to current serving SpCell and current serving SCells.

CMG is equivalent to currently non-serving candidate SpCell and currently non-serving candidate SCells.

A PCell/PSCell and a SCell in smg are called serving PCell/PSCell and serving SCell. A PCell/PSCell and a SCell in cmg are called candidate PCell/PSCell and candidate SCell.

UE and terminal are used interchangeably.

GNB and base station are used interchangeably.

PDCCH and downlink control channel are used interchangeably.

PDSCH and downlink shared channel and downlink traffic channel are used interchangeably.

PUCCH and uplink control channel are used interchangeably.

PUSCH and uplink shared channel and uplink traffic channel are used interchangeably.

Primary Cell and Primary SCG Cell are called SpCell.

CMG identifier in a MAC CE indicates RRCReconfiguration corresponding to a CMG.

CMG identifier in a MAC CE indicates the identifier of RRCReconfiguration applied to lower layer mobility).

CMG comprises a candidate SpCell and candidate SCells. SMG comprises serving SpCell and serving SCells.

The operations of the terminal are explained below.

### <Preamble Transmission Power>

The terminal transmits the UECapabilityInformation to the base station. The UECapabilityInformation includes capability information related to lower layer mobility. The terminal receives the RRCReconfigruation from the base station. The RRCReconfiguration includes UE specific search space configuration information for type1 PDCCH order monitoring and a first RNTI for type1 PDCCH order monitoring and common search space identifier for type2 PDCCH order monitoring and a second RNTI for type2 PDCCH order monitoring. The RRCReconfiguration includes one or more inner RRCReconfiguration and associated mobility group identifier.

The terminal receives a PDCCH order from the base station.

The terminal determines the transmission power of the preamble. If the PDCCH order is a type1 PDCCH order, preamble transmission power is determined based on a first parameter set and pathloss of a first cell. The first parameter set includes at least a preambleReceivedTargetPower. The first parameter set is included in the system information block1 of the first cell. If PDCCH order is a type2 PDCCH order, preamble transmission power is determined based on a second parameter set and a first information (CMG identifier) and a second information (transmission power related information) and pathloss of a second cell. The second parameter set includes at least a preambleReceivedTargetPower. The second parameter set is included in an inner RRCReconfiguration corresponding to the first information. The second cell is determined based on the first information. The second information indicates how much more transmission power is added to the transmission power determined based on the second parameter set and pathloss of the second cell.

The terminal transmits a preamble to the base station based on the PDCCH order.

### <Response and TTA>

The terminal transmits the UECapabilityInformation to the base station. The UECapabilityInformation includes capability information related to lower layer mobility.

The terminal receives the RRCReconfigruation from the base station. The RRCReconfiguration includes UE specific search space configuration information for type1 PDCCH order monitoring and a first RNTI for type1 PDCCH order monitoring and common search space identifier for type2 PDCCH order monitoring and a second RNTI for type2 PDCCH order monitoring. The RRCReconfiguration includes one or more inner RRCReconfiguration and associated mobility group identifier.

The terminal receives a PDCCH order from the base station. For type1 PDCCH order, the first RNTI and the UE specific search space determined from the UE specific search space configuration information are applied. For type2 PDCCH order, the second RNTI and the common search space determined from the common search space identifier are applied.

The terminal transmits a preamble to the base station based on the PDCCH order.

The terminal receives a response from the base station. A first response is received if type1 PDCCH order was received. A second response is received if type2 PDCCH order was received. For the first response and the second response, the UE specific search space determined from the UE specific search space configuration information is applied. For the first response, a third RNTI is applied. The third RNTI is predefined in the standard. For the second response, the first RNTI is applied.

The terminal determines Timing advance between downlink and uplink (TTA). If the type1 PDCCH order was received, the terminal determines TTA of a first cell based on the first field (TAC) and the subcarrier spacing for a first PUSCH transmission. The first cell is the cell where the first PDCCH order was received. The first PUSCH is the PUSCH transmission after the first response reception. If the type2 PDCCH order was received, the terminal determines TTA of a second cell based on the first field and the subcarrier spacing for the preamble transmission and the second field (CMG identifier).

### <TAC MAC CE>

The terminal transmits the UECapabilityInformation to the base station. The UECapabilityInformation includes capability information related to lower layer mobility.

The terminal receives the RRCReconfigruation from the base station. The RRCReconfiguration includes one or more inner RRCReconfiguration and associated mobility group identifier.

The terminal receives a TAC MAC CE in a first cell.

The terminal determines Timing advance between downlink and uplink (TTA).

If the type1 TAC MAC CE is received, the terminal determines Timing advance between downlink and uplink (TTA) of a second TAG of a first mobility group based on the first field (TAC) and the second field (TAG ID) and a first subcarrier spacing. The first mobility group is the current serving mobility group. The first TAG is the TAG indicated by the second field. The first subcarrier spacing is the largest subcarrier spacing of active uplink bandwidth parts of the first TAG of the first mobility group.

If the type2 TAC MAC CE is received, the terminal determines Timing advance between downlink and uplink (TTA) of a second TAG of a second mobility group based on the first field (TAC) and the second field (TAG ID) and a third field (CMG ID field) and a second subcarrier spacing. The second mobility group is determined based on the third field. The second TAG is the TAG indicated by the second field. The second subcarrier spacing is the subcarrier spacing of a specific uplink bandwidth part of a specific candidate cell of the second TAG of the second mobility group. The identifier of the specific uplink bandwidth part is indicated in the corresponding inner RRCReconfiguration. The configuration information of the specific candidate cell is indicated in the corresponding inner RRCReconfiguration. Alternatively, the specific uplink bandwidth part is the uplink bandwidth part with the lowest uplink bandwidth part identifier. Alternatively, the specific uplink bandwidth part is the uplink bandwidth part with a specific uplink bandwidth part identifier (e.g. 0). The specific candidate cell is the candidate cell with the lowest serving cell identifier. Alternatively, the specific candidate cell is the candidate cell with a specific serving cell identifier (e.g. 0)

### <Switching MAC CE>

The terminal transmits the UECapabilityInformation to the base station. The UECapabilityInformation includes capability information related to lower layer mobility.

The terminal receives the RRCReconfigruation from the base station. The RRCReconfiguration includes UE specific search space configuration information for type1 PDCCH order monitoring and a first RNTI for type1 PDCCH order monitoring and common search space identifier for type2 PDCCH order monitoring and a second RNTI for type2 PDCCH order monitoring. The RRCReconfiguration includes one or more inner RRCReconfiguration and associated mobility group identifier.

The terminal receives a PDCCH order from the base station. For type1 PDCCH order, the first RNTI and the UE specific search space determined from the UE specific search space configuration information are applied. For type2 PDCCH order, the second RNTI and the common search space determined from the common search space identifier are applied.

The terminal transmits a preamble based on the type2 PDCCH order for a first mobility group.

The terminal receives in a first cell a MAC CE for lower layer mobility execution toward the second mobility group. The first RNTI and the UE specific search space determined from the UE specific search space configuration information are applied for the MAC CE reception.

The terminal performs a first operation set in the first mobility group at a first point of time. The first operation set comprises stopping TAT and canceling BSR and canceling PHR. The first point of time is after the positive HARQ feedback for the MAC CE is transmitted and before the mobility group switch starts. The first cell belongs to the first mobility group.

The terminal performs a second operation set in the second mobility group at a second point of time. The second operation set comprises applying TTA having determined for the second mobility group based on the type2 PDCCH order. The second point of time is after the mobility group switch starts and before access to the target candidate cell is successfully completed.

The terminal performs a third operation set in the second mobility group at a third point of time. The third operation set comprises triggering BSR if has been cancelled and triggering PHR. The third point of time is after access to the target candidate cell is successfully completed and before the positive HARQ feedback for a second MAC CE (MOBILITY_GROUP_SWITCH_RESPONSE) is transmitted.

### <Short Candidate Id>

UE determines short-candidate-id as followings:
Short-candidate-id is determined as below:
>: UE first determines one or more first type LTM-CandidateToAddMod;
   >>: first type LTM-CandidateToAddMod is LTM-CandidateToAddMod with EarlyUL-SyncConfig (or RACH configuration for early sync; or RACH configuration for type 2 random access where only preamble transmission is performed);
   >>: second type LTM-CandidateToAddMod is LTM-CandidateToAddMod without EarlyUL-SyncConfig (or RACH configuration for early sync; or RACH configuration for type 2 RACH)
>: UE assigns short-candidate-id to each of first type LTM-CandidateToAddMod such that the lowest unreserved id is assigned to the first type LTM-CandidateToAddMod with lowest LTM-CandidateId, and the second lowest unreserved id is assigned to the first type LTM-CandidateToAddMod with second lowest LTM-CandidateId and so on;
>: UE assigns the reserved id to the current serving cell (e.g. current SpCell);
   >>: If reserved id is 0, the lowest unreserved id is 1.

For example as illustrated in 4C-11, short-candidate-id is:
0 for SpCell of current serving CG;
1 for SpCell of LTM-Candidate 0 (type1);
not allocated for SpCell of LTM-Candidate 1 (type2);
not allocated for SpCell of LTM-Candidate 2 (type2);
2 for SpCell of LTM-Candidate 3 (type1) and;
3 for SpCell of LTM-Candidate 4 (type1).

When UE receives a first PDCCH order, UE performs first random access procedure in the cell where the first PDCCH order is received.

When UE receives a second PDCCH order, UE performs second random access procedure in the cell indicated by the short-candidate-id in the second PDCCH order (e.g., if short-candidate-id is 2, the second random access procedure is performed in the SpCell of LTM-Candidate 3).

Format of MAC CE is a crucial factor for high performance in terms of processing efficiency and signaling overhead. LTM Cell Switch Command MAC CE (hereinafter LTM MAC CE) should be able to provide various information in flexible way and processing-friendly way. To ensure high performance in layer 2, byte-alignment is important. The reason is because layer 2 processor encodes and decodes bitstreams byte by byte. On the other hand, to minimize the overhead, placing similar information together and having R bits as small as possible. However, in processing point of view, such requirements are merely second importance.

### <The LTM Cell Switch Command MAC CE>

The LTM Cell Switch Command MAC CE is identified by MAC subheader with eLCID. It has a variable size with following fields.
>: R: Reserved bit, set to 0;
>: Target Configuration ID: This field indicates the index of candidate target configuration to apply for LTM cell switch, corresponding to ltm-CandidateId minus 1. The length of the field is 3 bits;
>: Timing Advance Command: This field indicates whether the TA is valid for the LTM target cell (i.e. the SpCell corresponding to the target configuration indicated by Target Configuration ID field). If the value of this field is set to FFF, this field indicates that no valid timing adjustment is available for the PTAG of the LTM target cell; Otherwise, this field indicates the index value TA used to control the amount of timing adjustment that the MAC entity has to apply in TS 38.213 [6], and that the UE can skip the Random Access procedure for this LTM cell switch. The length of the field is 12 bits;
>: TCI state ID: This field indicates and activates the TCI state for the LTM target cell (i.e. the SpCell of the target configuration indicated by the Target Configuration ID field). The TCI state is identified by TCI-StateId in ltm-DL-OrJointTCI-StateToAddModList. If the value of unifiedTCI-StateType in the configuration indicated by Target Configuration ID field is joint, this field is for joint TCI state, otherwise, this field is for downlink TCI state. The length of the field is 7 bits;
>: UL TCI state ID: This field indicates and activates the uplink TCI state for the LTM target cell (i.e. the SpCell of the target configuration indicated by the Target Configuration ID field). The most significant bits of UL TCI state ID are considered as reserved bits and the remainder 6 bits indicate the TCI-UL-StateId in ltm-UL-TCI-StatesToAddModList. This field is included if the value of unifiedTCI-StateType in the configuration indicated by Target Configuration ID field is separate. The length of the field is 8 bits;
>: C: This field indicates the presence of the contention-free Random Access Resources fields. If the value of this field is set to 1, the following fields are present, including Random Access Preamble index field, S/U field, SS/PBCH index field and PRACH Mask index field. If the value of this field is set to 0, Random Access Preamble index field, SS/PBCH index field and PRACH Mask index field are absent, and S/U field is considered as Reserved field.
>: S/U: This field indicates which UL carrier to transmit the PRACH of the contention-free Random Access Resources. If the value of this field is set to 1, SUL is used; otherwise, NUL is used. The length of the field is 1 bit;
>: S: This field locate in third MSB of the Octet 1 as referenced by 4D-11. This field indicates whether Security update is required or not. If the value of this field is set to 1, Security Counter is indicated in the first 4 bit of the Octet 2. If the value of this field is set to 1, UE performs security update (and PDCP re-establishment). If the value of this field is set to 0, UE does not perform security update.
>: Random Access Preamble index: This field indicates the Random Access Preamble index of the contention-free Random Access Resources. The length of the field is 6 bits;
>: SS/PBCH index: This field indicates the SS/PBCH that shall be used to determine the RACH occasion for the PRACH transmission of the contention-free Random Access Resources. The length of the field is 6 bits;
>: PRACH Mask index: This field indicates the RACH occasion(s) associated with the SS/PBCH indicated by “SS/PBCH index” for the PRACH transmission of the contention-free Random Access Resources, referring to the rach-ConfigDedicated (if not provided otherwise to the rach-ConfigCommon) in the UL BWP configuration of firstActiveUplinkBWP-Id. The length of the field is 4 bits.

### <Security Update MAC CE>

The Security Update MAC CE is transmitted by the UE to the new CU upon inter-CU LTM cell switch with subsequent security update (e.g. subsequent update condition group is fulfilled). Since MAC CE is not protected by security, specific information that are used to determine the used ltm-cs-counter based on shared information (e.g ltm-cs-Counter list associated with the target Security Cell Group) is indicated instead of ltm-cs-counter itself.

The Security Update MAC CE is identified by MAC subheader with eLCID. It has a fixed size of 1 byte with following fields.

Ltm-cs-Counter pointer: This field indicates the position of concerned ltm-cs-Counter within the original ltm-cs-Counter list.

### PDCCH Order

The base station may trigger random access of a specific UE by transmitting downlink control information designed to trigger random access. If uplink synchronization is about to be lost, the base station may transmit a PDCCH order, that is basically layer 1 downlink control information with specific fields set to specific values. For example, If the CRC of the DCI format 1_0 is scrambled by C-RNTI and the “Frequency domain resource assignment” field are of all ones, the DCI format 1_0 is for random access procedure initiated by a PDCCH order (layer 1 downlink control information for random access).

PDCCH order may trigger either contention based random access (CBRA) or contention free random access (CFRA). For CFRA, CFRA information may comprise following information:
index of preamble to be transmitted for the CFRA;
index of SS/PBCH with which RO for CFRA is determined;
indication indicating an uplink for CFRA between UL and SUL; and
index of PRACH mask with which available ROs for CFRA are determined.

PDCCH order 4E-11 may, besides identification for DCI formats field and frequency domain resource assignment field, comprise:

Random Access Preamble index field (6 bit; preamble field); or

Random Access Preamble index field, UL/SUL indicator field (1 bit; S/U field), SS/PBCH index field (6 bit; SSB field) and PRACH Mask index field (4 bit; PRACH mask field).

The presence of S/U field, SSB field and PRACH mask field is collectively indicated by preamble field. If the preamble field is all zeros, contention based random access is triggered CFRA information does not follow. If the preamble field is not all zeros, contention free random access is triggered and remaining CFRA information (e.g. S/U field and SSB field and PRACH mask field) follows.

random access may need to be triggered together with other operations such as LTM cell switch. In such case, putting the required information in a single information bundle instead of delivering LTM cell switch command and PDCCH order separately.

In this disclosure, CFRA info is merged into the LTM MAC CE. One can consider LTM MAC CE comprising CFRA information is layer 2 downlink control information for random access (L2 DCI for random access) 4E-21.

There are several differences between L1 DCI for random access 4E-11 and L2 DCI for random access 4E-21 in terms of CFRA information.

In L1 DCI for random access, the presence of S/U field and the SSB field and PRACH mask field are collectively determined based on the value in the preamble field that is configured to indicate the index of preamble.

In L2 DCI for random access, the presence of preamble field and S/U field and the SSB field and PRACH mask field are collectively determined based on a specific field that is configured to indicate the presence.

In L1 DCI for random access, preamble field and S/U field and SSB field and PRACH mask field are placed in that order.

In L2 DCI for random access, preamble field and SSB field and PRACH mask field and S/U field are placed in that order.

Above differences are to ensure best performance in each layer.

### L1 DCI:

is processed bit by bit; and
does not require byte alignment.

It is because L1 DCI is short information with limited types. Hence, it is possible to customize the processing for each DCI, which in turn deliver the best performance when the information is structured in hierarchical way. since uplink selection and SSB selection and applying PRACH mask occurs in sequence, the relevant information better placed in the same order.

### L2 DCI:

is processed byte by byte; and
requires byte alignment.

It is because L2 DCI is processed by high layer processor that is designed for bulk data processing with high speed. In this case, best performance is achieved if field itself or combination of fields are byte aligned. Preamble field and SSB field and PRACH mask field are collectively byte aligned. Hence, S/U field should be placed out of those fields instead of being placed between those fields.

In L2 DCI for random access, presence of second part of CFRA information is indicated by first part of CFRA information.

In the L2 DCI for random access, presence of CFRA information is indicated by explicit indication (e.g. C field).

The base station may decide to trigger random access of the UE in a serving cell of the UE. The base station transmits the UE L1 DCI for RA 4F-11. UE selects type of RA between CBRA and CFRA 4F-21. If the preamble field is all zeros, CBRA is selected. If the preamble field is not all zeros, CFRA is selected. At 4F-31, the UE and the base station perform CBRA or CFRA in the serving cell 4F-06.

For CBRA, UE selects followings based on the system information of the serving cell:
uplink to perform the random access between the normal uplink and the supplementary uplink;
beam to transmit the preamble (SSB index);
RO for preamble transmission (with assumption that all ROs are allowed e.g. no PRACH mask is configured); and
preamble index.

For CFRA, UE determines followings based on the relevant fields in the L1 DCI for RA:
uplink to perform the random access based on S/U field;
beam to transmit the preamble based on SSB field;
RO for preamble transmission based on PRACH mask field; and
preamble index based on preamble field.

The base station may decide to trigger random access of the UE in a candidate cell of the UE. The base station transmits the UE L2 DCI for RA 4F-41.

The UE determines, based on target configuration ID field in the L2 DCI for RA, the candidate cell where the random access will be performed 4F-51.

The UE determines type of RA between CBRA and CFRA 4F-61. If C field is zero, CBRA is selected. If the C field is not zero (e.g. one), CFRA is selected. At 4F-81, the UE and the base station perform CBRA or CFRA in the candidate cell 4F-71.

For CBRA, UE selects followings based on the configuration information of the candidate cell:
uplink to perform the random access between the normal uplink and the supplementary uplink;
beam to transmit the preamble (SSB index);
RO for preamble transmission (with assumption that all ROs are allowed e.g. no PRACH mask is configured); and
preamble index.

For CFRA, UE determines followings based on the relevant fields in the L2 DCI for RA:
uplink to perform the random access based on S/U field;
beam to transmit the preamble based on SSB field;
RO for preamble transmission based on PRACH mask field; and
preamble index based on preamble field.

LTM is a technique to reduce the handover delay by performing cell switch based on Layer 1 measurement and Layer 2 signaling. LTM is mainly applied for intra-CU scenario where source cell and target cell are connected to the same CU. In this case, since security entity (e.g. PDCP) resides in the CU, security can continue before, during and after LTM cell switch. To ensure seamless and fast mobility in inter-CU case, inter-CU LTM is also required. One issue to be resolved to enable inter-CU LTM is how to ensure sufficient security. Basic security principle is that forward/backward security shall be ensured between network nodes (such as CU), which means that 1) different CU shall use different security keys and 2) deriving security key of other node by a node based on its own security key shall be impossible. Another security principle is that a data stream/plain text shall be protected by different security key or different fresh input (e.g. COUNT). Otherwise, security key could be hacked.

In inter-CU LTM scenario, there are different types of cell switch.
>: CASE1: Source serving cell and target serving cell are connected to the same CU (e.g. intra-CU LTM)
>: Source serving cell and target serving cell are connected to different CUs (e.g. inter-CU LTM)
   >>: CASE2: The terminal has not visited the target serving cell during LTM operation.
   >>: CASE3: The terminal has visited the target serving cell during LTM operation.

In CASE1, security key update is not needed.

In CASE2 and CASE3, security key update is required. In conventional inter-CU mobility (e.g. inter-CU handover), security key update to ensure forward/backward security is performed based on NH/NCC/K_GNB. Upon inter-CU handover, GNB indicate NCC value to the UE. Then based on comparison between the indicated NCC and current NCC, UE may derive new K_GNB based on either NH associated with the indicated NCC or based on current K_GNB.

The conventional scheme may cause frequent refreshes of AMF key. In the key derivation hierarchy, initial K_GNB (or root K_GNB) is derived from K_AMF. Then NHs are derived from the root K_GNB and K_AMF in cascading manner. After fixed number of derivations, K_AMF is refreshed. Since UE in inter-CU LTM operation may switch back and forth between different CUs and more than one CUs may be involved in the LTM operation, if new NH is generated every cell switching, K_AMF refresh would happen more frequently than conventional inter-GNB mobility.

In the disclosure, to address the problem, new scheme is introduced. In the new scheme, candidate cells are grouped together to form a LTM Security Group. Cell switch within a LTM Security Group does not cause security key update. Cell switch between LTM Security Groups causes security key update.

Each LTM Security Group is associated with a NH (associated with and identified by a NCC). Each LTM Security Group is also associated with a list of ltm-cs-counters. Both NCC and ltm-cs-counter are integer. Range of NCC is 0 as lowest and 7 as highest. Range of ltm-cs-counter is 0 as lowest and 65535 as highest.

When UE mover from a cell of LTM Security Group m to a cell of LTM Security Group n, UE derives new K_GNB either based on NH associated with LTM Security Group m or based on old/latest K_GNB associated with LTM Security Group m. Deriving new K_GNB based on associated NH is called initial key update and deriving new K_GNB based on associated/old K_GNB is called subsequent key update.

UE determines to perform initial key update if the concerned cell switch is the first visit (cell switch) to the LTM Security Group during the ongoing LTM procedure/operation (e.g. after a LTM-config is configured and before the LTM-config is released). UE determines to perform subsequent key update if the concerned cell switch is not the first visit to the LTM Security Group.

Security update, Key update and security/key update are used interchangeably.

LTM procedure and LTM operation are used interchangeably.

TABLE 1

| | Initial Security/Key Update | Subsequent Security/Key Update |
|---|---|---|
| UE perspective | Performed when: | Performed when: |
| | >: Cell switch to a candidate cell | >: Cell switch to a candidate cell |
| | occurs; | occurs; |
| | >: LTM Security Group ID of the | >: LTM Security Group ID of the |
| | candidate cell is different from LTM | candidate cell is different from |
| | Security Group ID of the source cell; | LTM Security Group ID of the |
| | and | source cell; and |
| | >: UE has not visited (or has not | >: UE has visited (or has not |
| | performed cell switch to) any cell of | performed cell switch to) at least one |
| | the LTM Security Group (that the | cell of the LTM Security Group |
| | candidate cell belongs to) | (that the candidate cell belongs |
| | >>: Initial Security/Key Update has | to) |
| | not been performed for the LTM | >>: Initial Security/Key Update |
| | Security Group; or | has been performed for the LTM |
| | >>: NCC associated with the LTM | Security Group; or |
| | Security Group is not used/released | >>: NCC ssociated with the LTM |
| | (NCC associated with the LTM Security | Security Group is already used/ |
| | Group is valid); or | released (NCC associated with the |
| | >>: Old K_GNB associated with the | LTM Security Group is not valid); |
| | LTM Security Group does not exist/ | or |
| | is not stored (Valid K_GNB associated | >>: Old K_GNB associated with |
| | with the LTM Security Group does | the LTM Security Group exists/is |
| | not exist/is not stored) | stored (Valid K_GNB associated |
| | For initial update: | with the LTM Security Group |
| | >: NH associated with NCC is derived | exists/is stored) |
| | from K_AMF | For subsequent update: |
| | >: K_GNB is derived from the NH | >: K_GNB is derived from the |
| | >: UE releases the NCC and the NH | stored K_GNB and first ltm-cs- |
| | >: UE uses the K_GNB to derive key | counter in the list (or next ltm-cs- |
| | quadruplet (K_RRC_int, K_RRC_enc, | counter that has not been used; ltm- |
| | K_UP_int, K_UP_int) | cs-counter to be used = ltm-cs- |
| | Before UE switches to a candidate | counter that has been used most |
| | cell of different LTM Security Group | recently + 1) |
| | (e.g. when UE switches to a candidate | >: UE releases the used Itm-cs- |
| | cell of the same LTM Security Group): | counter from the list (or UE update |
| | >: PDCP SDUs are ciphered/deciphered | ltm-cs-counter that has been most |
| | by either K_RRC_enc or K_UP_enc | recently by incrementing 1) |
| | >: PDCP SDUs are integrity protected | >: UE uses the K GNB to derive |
| | and verified by either K_RRC_int | key quadruplet (K_RRC_int, K |
| | or K_UP_int | RRC_enc, K_UP_int, K_UP_int) |
| | Upon cell switch to a different LTM | Before UE switches to a candidate |
| | Security Group (cell switch to a cell | cell of different LTM Security |
| | of which Security Group ID is different | Group (e.g. when UE switches to |
| | from the Security Group ID of | a candidate cell of the same LTM |
| | the current serving cell): | Security Group): |
| | >: UE releases the key quadruplet. | >: PDCP SDUs are ciphered/deciphered |
| | >: UE stores the current K_GNB | by either K_RRC_enc or K_UP_enc |
| | | >: PDCP SDUs are integrity protected |
| | | and verified by either K_RRC |
| | | int or K_UP_int |
| | | Upon cell switch to a different LTM |
| | | Security Group (cell switch to |
| | | a cell of which Security Group |
| | | ID is different from the Security |
| | | Group ID of the current serving |
| | | cell): |
| | | >: UE releases the key quadruplet |
| | | >: UE stores the K_GNB |
| GNB/CU | Performed when: | Performed when: |
| perspective | >: Cell switch to a candidate cell | >: Cell switch to a candidate cell |
| | occurs; | occurs; |
| | >: the candidate cell is connected | >: the candidate cell is connected |
| | with/controlled by the CU and the soruce | with/controlled by the CU and the |
| | cell is connected with/controlled | soruce cell is connected with/ |
| | by other CU; and | controlled by other CU; and |
| | >: UE has not visited (or performed | >: UE has visited (or performed |
| | cell switch to) any cell of the CU | cell switch to) any cell of the |
| | >>: Initial Security/Key Update has | CU |
| | not been performed by the CU; or | >: Initial Security/Key Update h |
| | >: {NCC, NH} stored in the CU is | as been performed by the CU; or |
| | not used/released | >: {NCC, NH} in the CU has |
| | >: Old K_GNB does not exist/is not | already been used/released; or |
| | stored in the CU | >>: Old K_GNB exists/is stored in |
| | For initial update: | the CU |
| | >: K_GNB is derived from the NH | For initial update: |
| | >: CU releases the NCC and the NH | >: K_GNB is derived from the stored |
| | >: CU uses the K_GNB to derive key | K_GNB and first ltm-cs-counter |
| | quadruplet (K_RRC int, K_RRC_enc, | in the list (or next ltm-cs- |
| | K_UP_int, K_UP_int) | counter that has not been used; lt |
| | Before UE switches to a cell of other | m-cs-counter to be used = ltm-cs- |
| | CU: | counter that has been used most |
| | >: PDCP SDUs are ciphered/deciphered | recently + 1) |
| | by either K_RRC_enc or K_UP_enc | >: CU releases the used ltm-cs- |
| | >: PDCP SDUs are integrity protected | counter from the list (or UE update |
| | and verified by either K_RRC int | ltm-cs-counter that has been most |
| | or K_UP_int | recently by incrementing 1) |
| | Upon cell switch to a cell of other | >: CU uses the K_GNB to derive |
| | CU: | key quadruplet (K_RRC int, K_RRC_enc, |
| | >: CU releases the key quadruplet. | K_UP_int, K UP_int) |
| | >: CU stores the K_GNB | Before UE switches to a cell of |
| | | other CU: |
| | | >: PDCP SDUs are ciphered/deciphered |
| | | by either K_RRC enc or K_UP_enc |
| | | >: PDCP SDUs are integrity protected |
| | | and verified by either K_R |
| | | RC_int or K_UP_int |
| | | Upon cell switch to a a cell of other |
| | | CU |
| | | >: CU releases the key quadruplet. |
| | | >: CU stores the K GNB |

### Key Derivation

K_{gNB} and K_GNB and KNB-RAN are used interchangeably.

C [a, b, c, . . . ] is concatenation function that produces a bit stream where a and b and c and so on are concatenated in order.

KDF [x, y]=HMAC-SHA [x, y]. KDF [x,y] is a key derivation function that produces a bitstream of 256 bit based on input of x and y.

For KEY Derivation in CASE2 (e.g. new initial K_GNB needs to be derived, initial security update)

NH (ncc=n)=KDF [S, K_AMF]
>: S=C [FC, NH (ncc=n−1), Length]
>: NH associate with ncc n is derived by the KDF with input of a first bit stream and K_AMF.
>: The first bit stream is produced by NH associated with ncc n−1 (NH associated with previous ncc)
   K_GNB=KDF [S, NH (ncc=n)]
>: S=C [PCI, Length, ARFCN-DL, Length]
>: K_GNB associated with ncc n is derived by the KDF with input of a second bit stream and NH associated with ncc n
>: The second bit stream is produced by PCI and ARFCN.
>: As a result, initial K_GNB for NCC n is produced based on NH associated with NCC (n) and NH associated with NCC (n−1) and K_AMF

K_GNB is used to derive key quadruplet.

For KEY Derivation in CASE3 (subsequent K_GNB is derived from the previous K_GNB; subsequent security update)
K_GNB*=KDF [S, K_GNB]
>: S=C [LTM-Counter, Length]
>: As a result, subsequent K_GNB for NCC n is produced based on previous K_GNB and ltm-cs-Counter.
K_GNB* is used to derive key quadruplet.

### Terminologies/definitions

### Key-derivation Key (KDK)

>: Security key that is used one time to derive another Key (one-shot/time key for a session). It is used to derive child key for a fixed number of times. Then the key is refreshed based on its parent key.
>: K_AMF and K_GNB are key-derivation key.
>: K_AMF is used to derive fixed number of NHs. Each NH is used to derive a K_GNB.
>: K_GNB is used to derive a single instance of key quadruplet.
>: Key-derivation key is input to a specific KDF.

### Traffic Key (TK)

>: Encryption-key (ECK)
   >>: Security key that is used to cipher or decipher a bitstream/plain text/PDCP SDU.
   >>: Encryption-key is used continuously during a session (persistent key for a session).
   >>: K_RRC_enc and K_UP_enc are Encryption-key.
   >>: Encryption-key is input to a specific encryption/decryption algorithm.
>: Integrity Key (INK)
   >>: Security key that is used to provide integrity protection or verification to a bitstream/plain text/PDCP SDU.
   >>: Integrity Key is used continuously during a session (persistent key for a session).
   >>: K_RRC_int and K_UP_int are INK.
   >>: INK is input to a specific integrity algorithm.

### K_AMF

>: K_AMF is 256-bit bitstream (or Key-derivation Key) derived from higher key-derivation key and is used to derive K_GNB.
>: UE/ME (Mobile Equipment) derives K_AMF from higher level KDK based on NAS level security mode command procedures.
   >>: ME and USIM (Universal Subscribe Identity Module) together form the UE
>: Security Node in 5G CN derives K_AMF and informs it to AMF.

### NH

>: NH is 256-bit bitstream (or Key-derivation material) derived from K_AMF (in case for initial NH derivation) or from previous/another NH.
>: A single K_AMF produces at most 8 NHs. Each NH is associated with a short counter (e.g. NCC).
>: The short counter indicates the order of the associated NH in the NH chains of a K_AMF. If NCC is n, associated NH is n-th (or n+1-th) NH within a set of NHs derived from the K_AMF.

### Traffic Keys for UP Traffic

>: K_UP_enc is:
   >>: a key derived by ME/UE and GNB from K_GNB, which shall only be used for the protection of UP traffic between ME/UE and gNB with a particular encryption algorithm;
   >>: 128-bit bitstream (or ECK) derived based on K_GNB and a specific algorithm distinguisher; the specific algorithm distinguisher is an integer of a fixed value (0×05);
   >>: used for ciphering of uplink PDCP SDUs of DRBs.
   >>: used for deciphering of downlink PDCP SDUs of DRBs.
>: K_UP_int is:
   >>: a key derived by ME/UE and gNB from KgNB, which shall only be used for the protection of UP traffic between ME and gNB with a particular integrity algorithm;
   >>: 128-bit bitstream (of INK) derived based on K_GNB and a specific algorithm distinguisher; the specific algorithm distinguisher is an integer of a fixed value (0×06);
   >>: used for calculating/generating MAC-I of uplink PDCP SDUs of DRBs
   >>: used for verifying MAC-I of downlink PDCP SDUs of DRBs.

### Traffic Keys for RRC Signaling

>: K_RRC_enc is:
   >>: a key derived by ME/UE and GNB from K_GNB, which shall only be used for the protection of RRC signaling between ME/UE and gNB with a particular encryption algorithm;
   >>: 128-bit bitstream (or ECK) derived based on K_GNB and a specific algorithm distinguisher; the specific algorithm distinguisher is an integer of a fixed value (0×03);
   >>: used for ciphering of uplink PDCP SDUs of SRB1/SRB2/SRB4.
   >>: used for deciphering of downlink PDCP SDUs of SRB1/SRB2/SRB4.
>: K_RRC_int is:
   >>: a key derived by ME/UE and gNB from KgNB, which shall only be used for the protection of RRC signaling between ME and gNB with a particular integrity algorithm;
   >>: 128-bit bitstream (of INK) derived based on K_GNB and a specific algorithm distinguisher; the specific algorithm distinguisher is an integer of a fixed value (0×04);
   >>: used for calculating/generating MAC-I of uplink PDCP SDUs of SRB1/SRB2/SRB4.
   >>: used for verifying MAC-I of downlink PDCP SDUs of SRB1/SRB2/SRB4.
      K_GNB During Non-LTM Operation (e.g. While LTM-Configuration is not Configured)
>: K_GNB is 256-bit bitstream (or Key-derivation Key) derived from previous/another K_GNB or from NH and is used to derive key quadruplet.
>: ME derives K_GNB upon PDCP re-establishment caused due to handover.
>: GNB receives K_GNB from AMF (in case of RRC connection setup) or {NH, NCC} from another GNB (in case of inter-GNB handover).
>: GNB derives K_GNB from the NH.
>: GNB maintains/keeps a single K_GNB at a time.
>: UE/ME maintains/keeps a single K_GNB at a time.
>: UE/ME maintains at most a single NH at a time.

### K_GNB in Initial Security Update During LTM Operation

>: K_GNB is 256-bit bitstream (or Key-derivation Key) derived from a specific NH. NCC of the specific NH is indicated in the configuration information of the associated LTM security group (ID). Or NCC of the specific NH is indicated in LTM Cell Switch Command MAC CE
>: UE/ME derives K_GNB upon PDCP re-establishment caused due to type 1 LTM cell switch (LTM cell switch with initial security update).
>: GNB receives one or more {NH, NCC} s from AMF before inter-CU LTM operation starts.
>: GNB forwards {NH, NCC} s to other CUs (that are involved in inter-cu LTM operation); one pair for each CU; one pair for each LTM Security Group.
>: Each CU/LTM Security Group derives K_GNB from the NH.
>: Each CU/LTM maintains/keeps a single K_GNB at a time.
>: UE/ME receives one or more NCCs from GNB in inter-CU LTM configuration information. Each NCC is associated with a LTM Security Group (ID).
>: UE/ME derives one or more NHs based on KEY_AMF and NCCs. UE/ME associates each NH with a LTM Security Group (ID).
>: UE/ME maintains/keeps one or more K_GNBs at a time (simultaneously) during inter-CU LTM operation. Each corresponds to a CU/LTM Security Group (ID).
>: UE/ME maintains/keeps one or more NHs at a time (simultaneously) during inter-CU LTM operation. Each corresponds to a CU/LTM Security Group (ID).

### K_GNB in Subsequent Security Update During LTM Operation

>: K_GNB is 256-bit bitstream (or Key-derivation Key) derived from another/previous K_GNB. Each K_GNB is associated with a long counter (ltm-cs-Counter).
>: K_GNB chain is associated with a CU/LTM Security Group. K_GNB chain is set of K_GNBs where a K_GNB in the chain is used to derive the next K_GNB. Each K_GNB in the K_GNB chain is associated with a long counter.
>: The first K_GNB in the K_GNB chain is the K_GNB derived in the initial security update (e.g. K_GNB derived based on NH).
>: Long counter associated with a K_GNB indicates the order of the K_GNB in the K_GNB chain (e.g. K_GNB associated with long counter n is n-th (or n+1-th) K_GNB in the K_GNB chain.
>: Long counter associated with a K_GNB is used to an input to KDF to derive the next K_GNB in the K_GNB chain.
>: UE/ME derives next K_GNB based on current/stored K_GNB and next long counter upon PDCP re-establishment caused due to type 2 LTM cell switch (LTM cell switch with subsequent security update).
>: Each CU/LTM Security Group derives next K_GNB based on current/stored K_GNB and current long counter upon PDCP re-establishment caused due to type 2 LTM cell switch (LTM cell switch with subsequent security update).COUNTER
>: Two types of counters are used for key derivation for the purpose of backward/forward security (ensuring the derived key is not derived by 3rd party).
>: Short Counter (NCC) is:
   >>: a pointer for NH/KDK;
   >>: is used in initial security update;
   >>: indicates the position of NH in the NH chain
      >>>: NH chain comprises two or more NHs where first NH is an input to KDF for second NH derivation, second NH is an input to KDF for third NH derivation and so on. an (n−1)-th NH is an input to KDF for the n-th NH.
>: Long Counter (ltm-cs-counter) is:
   >>: a fresh input to the KDF for KDK;
   >>: is used in subsequent security update;
   >>: is an input (together with (n−1)th KDK) to the KDF for n-th KDK derivation.
   >>: A list of long counter is associated with a LTM Security Group (and set of candidate configurations of the Security Group).
   >>: UE start to use the first long counter in the list and remove the used long counter from the list.

### KDF

>: Key Derivation Function to derive KDK and TK.
>: In the present disclosure, HMAC-SHA-256 is applied.
>: HMAC-SHA (Hash-based Message Authentication Code with Secure Hash Algorithm)-256 is a cryptographic hash function with a secret key (e.g. NH) to generate a fixed-size hash value (e.g. K_GNB).
>: In case of subsequent security update, HMAC-SHA generates four 256 bit hash values based on K_GNB. 128 LSBs of each 256 bit hash value is a specific TK (e.g. K_UP_enc or K_RRC_int).

### Terminal Performs Followings:

receiving, by the terminal from a base station, a Radio Resource Control (RRC) reconfiguration message, wherein the RRC reconfiguration message comprises LTM configuration, wherein the LTM configuration comprises:
   one or more LTM candidate configuration, wherein each of the one or more LTM candidate configuration comprises an inner RRC reconfiguration message and an identifier related security update; and
   one or more LTM security group configuration, wherein each of the one or more LTM security group configuration comprises the identifier related security update (LTM Security Group ID; Security Group ID) and a NCC and a list of ltm-cs-Counter;
receiving, by the terminal in a first cell from the base station, a Medium Access Control (MAC) Control Element (CE) instructing cell switch operation, wherein the MAC CE comprises:
a Target Configuration ID; and
a NCC;
determining, by the terminal, LTM-candidateId of a candidate target configuration based on the Target Configuration ID plus one;
performing, by the terminal and based on the candidate target configuration, the cell switch operation without security update (or without PDCP reestablishment or without new security key derivation) in case that Security Group ID associated with the current/serving configuration (or current/serving ltm-CandidateId) and Security Group ID associated with Target Config ID (or associated with candidate target configuration) is same.

performing, by the terminal and based on the candidate target configuration, the cell switch operation with initial security update (or with PDCP reestablishment for initial security update) in case that initial update condition group is fulfilled.

### <Initial Update Condition Group>

Security Group ID associated with the current/serving configuration and Security Group ID associated with Target Config ID (or associated with candidate target configuration) is different; and
K_GNB is not available for the Security Group associated with the Target Config ID (or NH/NCC of the Security Group associated with the Target Config ID is available; or terminal performs cell switch to the security group associated with the Target Config ID first time)

### <Alternative Initial Update Condition Group>

NCC associated with the current/serving configuration and NCC indicated in the MAC CE is different; and
NCC indicated in the MAC CE is different from a specific NCC. The specific NCC is NCC associated with the candidate target configuration.
performing, by the terminal and based on the candidate target configuration, the cell switch operation with subsequent security update (or with PDCP reestablishment for subsequent security update) in case that subsequent update condition group is fulfilled.

### <Subsequent Update Condition Group>

Security Group ID associated with the current/serving configuration and Security Group ID associated with Target Config ID is different; and
K_GNB is available for the Security Group associated with the Target Config ID (or NH/NCC of the Security Group associated with the Target Config ID is not available; or it is not the first time for terminal to perform cell switch to the security group associated with the Target Config ID; or K_GNB is available/stored for the Security Group associated with the Target Config ID)

### <Alternative Subsequent Update Condition Group>

NCC associated with the current/serving configuration and NCC indicated in the MAC CE is different; and
NCC indicated in the MAC CE is same as a specific NCC. The specific NCC is NCC associated with the candidate target configuration.

Candidate target configuration is RRC configuration indicated in the inner RRC message associated with a specific LTM-Candidate/ltm-CandidateId; the specific LTM-Candidate/ltm-CandidateId is determined based on Target Configuration ID.

Current/serving configuration is RRC configuration indicated in the inner RRC message associated with a specific LTM-Candidate/ltm-CandidateId; the specific LTM-Candidate/ltm-CandidateId is related to currently applied LTM-Candidate.

A Target Config ID/candidate target configuration is associated with a Security Group ID/Security Group in case that LTM-Candidate/ltm-CandidateId associated with the Target Config ID/candidate target configuration comprises the corresponding Security Group ID.

A LTM security group is associated with a LTM candidate configuration in case that the corresponding LTM Security Group ID is indicated in the LTM-Candidate IE.

A LTM security group is associated with a Target Config ID in case that at least one LTM-CandidateId associated with the LTM Security Group is equal to Target Config ID minus 1.

A LTM Security Group comprises one or more LTM-Candidates. A LTM Security Group is associated with one or more LTM-CandidateIds.

A NCC is associated with a candidate target configuration if the NCC is associated with security cell group of the candidate target configuration.

A NCC is associated with a serving/current configuration if the NCC is associated with security cell group of the serving/current configuration.

For the initial security update, terminal performs followings:
receiving, by the terminal in a first cell, a LTM Cell Switch Command MAC CE;
deriving, by the terminal, a first KDK (K_GNB) based on a specific NH in case that the initial update condition group is fulfilled;
deriving, by the terminal, TKs based on the first KDK; and
performing security protection for PDCP SDUs based on TKs,
wherein the terminal determines a specific NCC based on the MAC CE;
wherein the terminal determines an input-NH based on the specific NCC (the input-NH is NH associated with the specific NCC−1)
NCC n is associated with a NH in case that the NH is derived from a NH that is associated with NCC n−1.
wherein the terminal derives the specific NH (associated with the specific NCC) based on the input KDK (K_AMF) and the input-NH (NH associated with NCC-1; immediately previous NH);
wherein the terminal derives the first KDK (K_GNB) based on the specific NH and a specific PCI and a specific ARFCN-DL;
wherein the specific PCI is determined based on a specific parameter [ltm-CandidatePCI] in candidate target configuration; the specific parameter is comprised outside the inner RRC reconfiguration message.

wherein the specific ARFCN-DL is determined based on a specific parameter [absoluteFrequencySSB] in candidate target configuration; the specific parameter is comprised in the inner RRC reconfiguration message.

wherein first KDK is a one-shot key that is used once before released,

wherein TKs are persistent keys that are used two or more times (and persistently) before released.

For Subsequent Security update:
receiving, by the terminal in a first cell, a LTM Cell Switch Command MAC CE;
deriving, by the terminal, a second KDK (K_GNB) based on a specific KGNB and a specific ltm-cs-Counter in case that the subsequent update condition group is fulfilled;
deriving, by the terminal, TKs based on the second KDK; and
performing security protection for PDCP SDUs based on TKs,
wherein the terminal determines the specific KGNB based on the MAC CE; the specific KGNB is latest/stored KGNB of the LTM Security Group associated with the target candidate configuration;
wherein the terminal determines the specific ltm-cs-Counter based on the MAC CE; the specific ltm-cs-Counter is the first (unused) ltm-cs-Counter in the ltm-cs-Counter list of the LTM Security Group associated with the target candidate configuration.

After successful PDCP reestablishment that has been initiated by reception of the MAC CE (or in case that Security Group ID associated with the current/serving configuration and Security Group ID associated with Target Config ID (or associated with candidate target configuration) is different), the terminal generates a RRC reconfiguration.

Wherein the RRC reconfiguration message comprises information on NCC that is used for KDK/TK derivation in case that initial update condition group is fulfilled; the information on NCC is an integer equal to the NCC.

Wherein the RRC reconfiguration message comprises information on ltm-cs-Counter used for KDK/TK derivation in case that subsequent update condition group is fulfilled. The information on ltm-cs-Counter is an integer equal to the order of ltm-cs-Counter in the ltm-cs-Counter list.

The terminal generates a Security Update MAC CE and RRCReconfigurationComplete after successful PDCP reestablishment that has been initiated by reception of the MAC CE in case that subsequent update condition group is fulfilled.

The terminal generates RRCReconfigurationComplete (and not generate Security Update MAC CE) after successful PDCP reestablishment that has been initiated by reception of the MAC CE in case that initial update condition group is fulfilled.

The terminal ensures that Security Update MAC CE is transmitted first and RRCReconfigurationComplete next.

The security and UP handling during LTM procedure should be carefully designed to handle various scenarios. For example, the UE needs to perform PDCP reestablishment if CU changes due to LTM. Table below explains summarize the required UP/Security handlings.

L3M and L3RM and L3SR and handover are used interchangeably.

LTM and L2RM and L2SR and lower layer triggered mobility are used interchangeably.

TABLE 2

| | Handover (L3M) | Intra-CU LTM | Inter-CU LTM |
|---|---|---|---|
| MAC | Unconditionally | Unconditionally | Unconditionally |
| | reset | reset | reset |
| RLC | Reestablish or continue | Reestablish or | Unconditionally |
| | based on reestablish | continue based on ltm- | reestablish |
| | RLC | NoResetID | |
| PDCP | Reestablish or continue | Unconditionally | Unconditionally |
| | based on reestablish | continue | reestablish |
| | PDCP | | |
| Security Key; | KSCI = True, then | Unconditionally | Unconditionally |
| | UE updates K_GNB | continue | update |
| | based on K_AMF | | If NH is not dervied |
| | this case does not | | yet for the LTM |
| | applied to HO. | | Security Group of the |
| | KSCI = False & NCC = | | new cell, initial |
| | different, then UE | | securty update is |
| | applies vertical key | | applied. |
| | derivation. | | If NH has been |
| | update K_GNB based | | derived and used for |
| | on NH | | deriving K_GNB of |
| | KSCI = False & NCC = | | the LTM Security |
| | same, then UE | | Group of the new |
| | applies horizontal key | | cell, subsequent |
| | derivation. | | security update is |
| | update K_GNB based | | applied. |
| | on current K_GNB | | |
| ROHC | Continue or reset based | Unconditionally | Continue or reset |
| | on drb-ContinueROHC | continue | based on drb- |
| | | | ContinueRohcId |

To support inter-CU LTM, new signaling and new UE behavior should be defined.

At 4G-11, UE receives from the base station a downlink control message comprising LTM-Config. UE stores LTM-Config in VarLTM-Config.

Terminal derives, for each LTM security group, a NH associated with the LTM security group.

NH is derived based on NCC indicated for the LTM security group.

At 4G-21, UE receives from the base station a downlink control message instructing network-controlled cell level mobility from a first cell to a second cell.

At 4G-31, UE determines whether to perform PDCP re-establishment for a set of radio bearers.

In case that the downlink control message is a RRCReconfiguration message, PDCP re-establishment for a set of radio bearers and RLC re-establishment for a set of RLC bearers are performed.
>: The RRCReconfiguration message is a standalone/outer RRC message (e.g. RRC message is not part of other RRC message);
>: The RRCReconfiguration message includes a masterCellGroup field.
>: The masterCellGgroup field includes a Reconfiguration WithSync IE.

The set of radio bearers includes one or more specific SRBs and one or more specific DRBs.
>: Each of the one or more specific SRBs is bearer that configured with reestablishPDCP field in the associated PDCP-Config IE.
>: Each of the one or more specific DRBs is bearer that configured with reestablishPDCP field in the associated PDCP-Config IE.

The set of RLC bearers includes one or more RLC bearers. Each of the one or more RLC bearers is RLC bearer that configured with reestablishRLC field in the associated RLC-Config IE.

In case that the downlink control message is a specific MAC CE, PDCP re-establishment is performed for none of radio bearers in case that:
>: The specific MAC CE is LTM Cell Switch Command MAC CE that includes Target Config ID field indicating a specific ltm-CandidateId;
   >>: The specific ltm-CandidateId is identifier of a specific LTM-Candidate IE (the specific ltm-CandidateId is ltm-CandidateId of target candidate cell).
   >>: ltm-SecurityCellSetId of the specific LTM-Candidate IE is same as ltm-SecurityCellSetId of the LTM-Candidate IE of the serving/source cell (e.g. Ltm-securityCellSetId of the serving/source cell is same as Ltm-securityCellSetId of the target/candidate cell; Ltm-securityCellSetId of the specific LTM-Candidate IE is same as ltm-ServingSecurityCellSetID); or
>: LTM Cell Switch Command MAC CE that includes a S field set to 0.

PDCP re-establishment is not performed if the target/candidate cell and the source/serving cell are associated with the same ltm-SecurityCellSetId.

RLC re-establishment is not performed if the target/candidate cell and the source/serving cell are associated with the same ltm-SecurityCellSetId.

In case that the downlink control message is a second specific MAC CE, PDCP re-establishment is performed for all radio bearers in case that:
>: The second specific MAC CE is LTM Cell Switch Command MAC CE that includes Target Config ID field indicating a second specific ltm-CandidateId;
   >>: The second specific ltm-CandidateId is identifier of a second specific LTM-Candidate IE.
   >>: Ltm-securityCellSetId of the second specific LTM-Candidate IE is different from Ltm-securityCellSetId of the LTM-Candidate IE of the serving/source cell (e.g. Ltm-securityCellSetId of the serving/source cell is different from Ltm-securityCellSetId of the target/candidate cell; Ltm-securityCellSetId of the second specific LTM-Candidate IE is different from ltm-ServingSecurityCellSetID).
>: LTM Cell Switch Command MAC CE that includes a S field set to 1.

PDCP re-establishment is performed for all radio bearers that are configured when the MAC CE is received if the target/candidate cell and the source/serving cell are associated with the different ltm-SecurityCellSetIds.

RLC re-establishment is not performed for all RLC bearers that are configured when the MAC CE is received if the target/candidate cell and the source/serving cell are associated with the different ltm-SecurityCellSetIds.

In case that the downlink control message is a RRCReconfiguration message, security key update is performed in case that:
>: The RRCReconfiguration message is a standalone RRC message (e.g. RRC message that does not comprise other RRC message);
>: The RRCReconfiguration message comprises a masterKeyUpdate field.

In case that the downlink control message is a specific MAC CE, security key update is not performed in case that:
>: The specific MAC CE is LTM Cell Switch Command MAC CE that comprises Target Config ID field indicating a specific ltm-CandidateId;
   >>: The specific ltm-CandidateId is identifier of a specific LTM-Candidate IE.
   >>: Ltm-securityGroupId of the specific LTM-Candidate IE is same as Ltm-securityGroupId of the LTM-Candidate IE of the serving/source cell (e.g. Ltm-securityGroupId of the serving/source cell is same as Ltm-securityGroupId of the target/candidate cell; Ltm-securityGroupId of the specific LTM-Candidate IE is same as ltm-ServingSecurityCellSetID); or
>: LTM Cell Switch Command MAC CE that comprises a S field set to 0.

Security update is not performed when the MAC CE is received if the target/candidate cell and the source/serving cell are associated with the same ltm-SecurityGroupId.

In case that the downlink control message is a second specific MAC CE, security key update is performed for all radio bearers in case that:
>: The second specific MAC CE is LTM Cell Switch Command MAC CE that comprises Target Config ID field indicating a second specific ltm-CandidateId;
   >>: The second specific ltm-CandidateId is identifier of a second specific LTM-Candidate IE.
   >>: Ltm-securityGroupId of the second specific LTM-Candidate IE is different from Ltm-securityGroupId of the LTM-Candidate IE of the serving/source cell (e.g. Ltm-securityGroupId of the serving/source cell is different from Ltm-securityGroupId of the target/candidate cell; Ltm-securityGroupId of the second specific LTM-Candidate IE is different from ltm-ServingSecurityCellSetID).
>: LTM Cell Switch Command MAC CE that comprises a S field set to 1.

Security update is performed when the MAC CE is received if the target/candidate cell and the source/serving cell are associated with the different ltm-SecurityGroupIds.

UE performs either initial security update or subsequent security update.

In case that the downlink control message is a RRCReconfiguration message, ROHC reset is performed for a set of DRBs.
>: The RRCReconfiguration message is a standalone/outer RRC message (e.g. RRC message is not part of other RRC message);
>: The RRCReconfiguration message includes a masterCellGroup field.
>: The masterCellGgroup field includes a Reconfiguration WithSync IE.

The set of DRBs includes one or more specific DRBs.
>: Each of the one or more specific DRBs is bearer that is configured with rohc (or uplinkOnlyROHC field) but not configured with drb-ContinueROHC field in the associated PDCP-Config IE.

In case that the downlink control message is a specific MAC CE, ROHC reset is performed for none of DRBs in case that:
>>: The specific MAC CE is LTM Cell Switch Command MAC CE that includes Target Config ID field indicating a specific ltm-CandidateId;
   >>>: The specific ltm-CandidateId is identifier of a specific LTM-Candidate IE (the specific ltm-CandidateId is ltm-CandidateId of target candidate cell).
   >>>: drb-ContinueRohcId of the specific LTM-Candidate IE is same as drb-ContinueRohcId of the LTM-Candidate IE of the serving/source cell (e.g. drb-ContinueRohcId of the serving/source cell is same as drb-ContinueRohcId of the target/candidate cell; drb-ContinueRohcId of the specific LTM-Candidate IE is same as servingDrb-ContinueRohcId); or
>>: LTM Cell Switch Command MAC CE that includes a S field set to 0.

ROHC reset is not performed if the target/candidate cell and the source/serving cell are associated with the same drb-ContinueRohcId.

In case that the downlink control message is a second specific MAC CE, ROHC reset is performed for all radio bearers in case that:
>>: The second specific MAC CE is LTM Cell Switch Command MAC CE that includes Target Config ID field indicating a second specific ltm-CandidateId;
   >>>: The second specific ltm-CandidateId is identifier of a second specific LTM-Candidate IE.
   >>>: drb-ContinueRohcId of the second specific LTM-Candidate IE is different from drb-ContinueRohcId of the LTM-Candidate IE of the serving/source cell (e.g. drb-ContinueRohcId of the serving/source cell is different from drb-ContinueRohcId of the target/candidate cell; drb-ContinueRohcId of the second specific LTM-Candidate IE is different from ServingDrb-ContinueRohcId).
>>: LTM Cell Switch Command MAC CE that includes a S field set to 1.

ROHC reset is performed for DRBs (for which ROHC is configured and are part of current UE configuration) when the MAC CE is received if the target/candidate cell and the source/serving cell are associated with the different drb-ContinueRohcId.

In case that the downlink control message is a RRCReconfiguration message, EHC reset is performed for a set of DRBs.
>: The RRCReconfiguration message is a standalone/outer RRC message (e.g. RRC message is not part of other RRC message);
>: The RRCReconfiguration message includes a masterCellGroup field.
>: The masterCellGgroup field includes a Reconfiguration WithSync IE.

The set of DRBs includes one or more specific DRBs.
>: Each of the one or more specific DRBs is bearer that is configured with EthernetHeaderCompression but not configured with drb-ContinueEHC-DL/-UL fields in the associated PDCP-Config IE.

In case that the downlink control message is a specific MAC CE, EHC reset is performed for none of DRBs in case that:
>>: The specific MAC CE is LTM Cell Switch Command MAC CE that includes Target Config ID field indicating a specific ltm-CandidateId;
   >>>: The specific ltm-CandidateId is identifier of a specific LTM-Candidate IE (the specific ltm-CandidateId is ltm-CandidateId of target candidate cell).
   >>>: drb-ContinueEHCId of the specific LTM-Candidate IE is same as drb-ContinueEHCId of the LTM-Candidate IE of the serving/soruce cell (e.g. drb-ContinueEHCId of the serving/source cell is same as drb-ContinueEHCId of the target/candidate cell; drb-ContinueEHCId of the specific LTM-Candidate IE is same as servingDrb-ContinueEHCId); or
>>: LTM Cell Switch Command MAC CE that includes a S field set to 0.

EHC reset is not performed if the target/candidate cell and the source/serving cell are associated with the same drb-ContinueEHCId.

In case that the downlink control message is a second specific MAC CE, EHC reset is performed for all radio bearers in case that:
>>: The second specific MAC CE is LTM Cell Switch Command MAC CE that includes Target Config ID field indicating a second specific ltm-CandidateId;
   >>>: The second specific ltm-CandidateId is identifier of a second specific LTM-Candidate IE.
   >>>: drb-ContinueEHCId of the second specific LTM-Candidate IE is different from drb-ContinueEHCId of the LTM-Candidate IE of the serving/soruce cell (e.g. drb-ContinueEHCId of the serving/source cell is different from drb-ContinueEHCId of the target/candidate cell; drb-ContinueEHCId of the second specific LTM-Candidate IE is different from ServingDrb-ContinueEHCId).
>>: LTM Cell Switch Command MAC CE that includes a S field set to 1.

EHC reset is performed for DRBs (for which EHC is configured and are part of current UE configuration) when the MAC CE is received if the target/candidate cell and the source/serving cell are associated with the different drb-ContinueEHCId.

At 4G-41, UE performs a first set of operations as below.

In case that the downlink control message is the specific RRC message, the UE:
>: Reset the MAC entity;
>: Configure lower layers in accordance with the spCellConfigCommon in the specific RRC message;
>: Re-establish a specific set of RLC entities;
   >>: The specific set of RLC entities comprieses RLC entities for which reestablishRLC is received (e.g. In case that RLC-BearerConfig of a RLC entity include reestablishRLC, the RLC entity belongs to the first set of RLC entities)
>: Determines the values for timers T301, T310, T311 and constants N310, N311;
   >>: In case that rlf-TimersAndConstants is included in SpCellConfig of the specific RRC message:
      >>>: use values for timers T301, T310, T311 and constants N310, N311, as included in rlf-TimersAndConstants;
   >>: In case that rlf-TimersAndConstants is not included in SpCellConfig of the specific RRC message:
      >>>: use values for timers T301, T310, T311 and constants N310, N311, as included in rlf ue-TimersAndConstants received in SIB1;
>: Configure a specific set of PDCP entities with new security keys;
   >>: The specific set of PDCP entities includes PDCP entities for which reestablishPDCP is received (e.g In case that PDCP-Config of a PDCP entity includes reestablishPDCP, the PDCP entity belongs to the first set of PDCP entities).
>: Re-establish the specific set of PDCP entities.
>: Determine whether to perform ROHC reset for third specific DRBs;
>: Perform ROHC reset according to the determination.
>: Perform data recovery for a second specific set of PDCP entities.
   >>: The second specific set of PDCP entities includes PDCP entities for which recoverPDCP is received (e.g In case that PDCP-Config of a PDCP entity includes recoverPDCP, the PDCP entity belongs to the first set of PDCP entities)

In case that the downlink control message is the specific MAC CE, UE performs followings:
>: Determine to use the default values for timers T310, T311 and constants N310, N311 associate to cell group for which the LTM cell switch procedure is triggered;
>: Reset the MAC entity;
>: Configure lower layers in accordance with the spCellConfigCommon in the LTM-Candidate in VarLTM-Config indicated by lower layers;
   >>: the LTM-Candidate in VarLTM-Config indicated by lower layers is the LTM-Candidate of which ltm-CandidateId is equal to Target Configuration ID plus 1)
>: Re-establish a specific set of RLC entities in case that the value of field ltm-NoResetID contained within the LTM-Candidate IE in VarLTM-Config indicated by lower layers is not equal to the value of ltm-ServingCellNoResetID within VarLTM-ServingCellNoResetID;
   >>: The specific set of RLC entities comprises all RLC entities that are part of the current UE configuration for the cell group for which the LTM cell switch procedure is triggered.
>: Perform data recovery for a specific set of PDCP entities.
   >>: The specific set of PDCP entities includes all AM DRBs that are part of the current UE configuration for the cell group for which the LTM cell switch procedure is triggered.
>: Determine whether to perform ROHC reset for specific DRBs;
>: Perform ROHC reset according to the determination.
>: replace the value of ltm-ServingCellNoResetID in VarLTM-ServingCellNoResetID with the value of ltm-NoResetID in the LTM-Candidate in VarLTM-Config indicated by lower layers;
>: replace the value of ltm-ServingCellUE-MeasuredTA-ID in VarLTM-ServingCellUE-MeasuredTA-ID with the value received within ltm-UE-MeasuredTA-ID; ltm-ServingCellNoResetID is updated after RLC re-establishment is performed to make proper decision on whether to perform RLC re-establishment or not.

In case that the downlink control message is the second specific MAC CE, UE performs followings:
>: Determine to use the default values for timers T310, T311 and constants N310, N311 associate to cell group for which the LTM cell switch procedure is triggered;
>: Reset the MAC entity;
>: Configure lower layers in accordance with the spCellConfigCommon in the LTM-Candidate in VarLTM-Config indicated by lower layers;
>: Re-establish a specific set of RLC entities in case that the value of field ltm-NoResetID contained within the LTM-Candidate IE in VarLTM-Config indicated by lower layers is not equal to the value of ltm-ServingCellNoResetID within VarLTM-ServingCellNoResetID;
   >>: The specific set of RLC entities comprises all RLC entities that are part of the current UE configuration for the cell group for which the LTM cell switch procedure is triggered.
>: Determine whether to update the security configurations/keys of a specific set of PDCP entities or continue the security configuration/keys of the specific set of PDCP entities.
   >>: Update the security configurations/keys (to be used during and after LTM Cell switching procedure) in case that the value of field ltm-securityCellSetId associated with the LTM-Candidate IE in VarLTM-Config indicated by lower layers is not equal to the value of ltm-ServingsecurityCellSetId within VarLTM-ServingsecurityCellSetId;
   >>: Continue to use (during and after LTM Cell switching procedure) the security configurations/keys in case that the value of field ltm-securityCellSetId associated with the LTM-Candidate IE in VarLTM-Config indicated by lower layers is equal to the value of ltm-ServingsecurityCellSetId within VarLTM-ServingsecurityCellSetId;
>: Update or continue to use the security configurations/keys according to the determination;
>: Determine whether to re-establish the specific set of PDCP entities.
   >>: Determine to re-establish the specific set of PDCP entities in case that the value of field ltm-securityCellSetId associated with the LTM-Candidate IE in VarLTM-Config indicated by lower layers is not equal to the value of ltm-ServingsecurityCellSetId within VarLTM-ServingsecurityCellSetId;
   >>: Determine to not re-establish the specific set of PDCP entities in case that the value of field ltm-securityCellSetId associated with the LTM-Candidate IE in VarLTM-Config indicated by lower layers is equal to the value of ltm-ServingsecurityCellSetId within VarLTM-ServingsecurityCellSetId;
>: Configure the specific set of PDCP entities with new security configurations/keys, if updated;
>: Re-establish or do not re-establish the specific set of PDCP entities according to the determination;
   >>: The specific set of PDCP entities includes:
      >>>: PDCP entity of SRB1, of SRB2 and of SRB4;
      >>>: PDCP entity of AM DRB
      >>>: PDCP entity of UM DRB
>: Determine whether to perform ROHC reset for specific DRBs;
>: Perform ROHC reset according to the determination.
>: replace the value of ltm-ServingCellNoResetID in VarLTM-ServingCellNoResetID with the value of ltm-NoResetID in the LTM-Candidate in VarLTM-Config indicated by lower layers;
>: replace the value of ltm-ServingCellUE-MeasuredTA-ID in VarLTM-ServingCellUE-MeasuredTA-ID with the value received within ltm-UE-MeasuredTA-ID;
>: replace the value of ltm-ServingsecurityCellSetId in VarLTM-ServingsecurityCellSetId with the value of ltm-SecurityCellSetID in the LTM-Candidate in VarLTM-Config indicated by lower layers.
>: replace the value of drb-ContinueRohcId in VarServingDrb-ContinueRohcId with the value of drb-ContinueRohcId in the LTM-Candidate in VarLTM-Config indicated by lower layers.

Note that ServingDrb-ContinueRohcId is updated after ROHC reset is performed to make proper decision on whether to perform PDCP re-establishment or not.

At 4G-51, UE generates a Security Update MAC CE and a RRCReconfigurationComplete message. At 4G-61, UE performs second set of operations as below.

UE indicates TA report information to lower layer if ta-Report or ta-ReportATG is configured with value enabled

At 4G-71, UE transmits to the base station Security Update MAC CE and the RRCReconfigurationComplete message.

To transmit RRCReconfigurationComplete,

UE monitors PDCCH for uplink transmission in case that:
>: cell level mobility is triggered by reception of LTM Cell Switch MAC CE; and
>: Timing Advance Command field is set to FFF.

UE triggers a random access procedure in case that:
>: cell level mobility is triggered by reception of LTM Cell Switch MAC CE; and
>: Timing Advance Command field is set to other than FFF.

For PDCCH monitoring, C-RNTI in SpCellConfig IE of the LTM-Candidate indicated by Target Configuration ID is used.

Random access procedure is performed in the uplink of target/candidate cell.

In inter-CU LTM, UE uses different security keys when CU/GNB changes. Instead of discarding old security keys, GNB may store the old keys and use them again when returning to the CU. To address key stream reuse problem (e.g. using the same security inputs to different key stream), new PDCP re-establishment procedure is defined for AM bearer and UM bearer.

LTM Cell switch procedure is triggered and completed as below.
>: LTM Cell switch procedure is triggered when LTM Cell Switch Command MAC CE is received.
>: LTM Cell switch procedure is completed:
   >>: in case that Timing Advance Command in LTM Cell Switch Command MAC CE indicates value other than FFF (e.g. UE skips RACH for this LTM Cell switch)
      >>>: when the downlink assignment has been received on the PDCCH of the target candidate cell for a C-RNTI for a new transmission after reception of the LTM Cell Switch Command MAC CE (or transmission of HARQ ACK for the MAC CE); or
      >>>: when the uplink grant has been received on the PDCCH of the target candidate cell for a C-RNTI for a new transmission after reception of the LTM Cell Switch Command MAC CE (or transmission of HARQ ACK for the MAC CE).
      >>>: The C-RNTI is indicated in ReconfigurationWithSync associated with the Target Configuration ID of the received LTM Cell Switch Command MAC CE.
   >>: in case that Timing Advance Command in LTM Cell Switch Command MAC CE indicates FFF (e.g. UE performs RACH for this LTM Cell switch)
      >>>: when RACH procedure is successfully completed in the target candidate cell.

LTM-Config-r18 ::= SEQUENCE {

| | |
|---|---|
| ltm-ReferenceConfiguration-r18 | SetupRelease |
| {ReferenceConfiguration-r18} | OPTIONAL, -- Need |

M

| | |
|---|---|
| ltm-Candidate ToReleaseList-r18 | SEQUENCE (SIZE |
| (1..maxNrofLTM-Configs-r18)) OF LTM-CandidateId-r18 | OPTIONAL, -- Need N |
| ltm-CandidateToAddModList-r18 | SEQUENCE (SIZE |
| (1..maxNrofLTM-Configs-r18)) OF LTM-Candidate-r18 | OPTIONAL, -- Need N |
| ltm-ServingCellNoResetID-r18 | INTEGER (1..maxNrofLTM- |
| Configs-r18-plus-1) | OPTIONAL, -- Cond FirstLTM-Only |
| ltm-CSI-ResourceConfigToAddModList-r18 | SEQUENCE (SIZE |

(1..maxNrofLTM-CSI-ResourceConfigurations-r18)) OF LTM-CSI-ResourceConfig-r18
OPTIONAL, -- Need N

| | |
|---|---|
| ltm-CSI-ResourceConfigToReleaseList-r18 | SEQUENCE (SIZE |

(1..maxNrofLTM-CSI-ResourceConfigurations-r18)) OF LTM-CSI-ResourceConfigId-r18
OPTIONAL, -- Need N

| | |
|---|---|
| attemptLTM-Switch-r18 | ENUMERATED {true} |

OPTIONAL, -- Cond LTM-MCG

| | |
|---|---|
| ltm-ServingCellUE-MeasuredTA-ID-r18 | INTEGER (1..maxNrofLTM- |
| Configs-r18-plus-1) | OPTIONAL, -- Cond LTM |
| ltm-SecurityCellSetID | INTEGER |
| (1..maxNrofLTM-Configs-r18-plus-1) | OPTIONAL, |

```
    ...
  }
```

| | |
|---|---|
| maxNrofLTM-Configs-r18-plus-1 | INTEGER ::= 9 -- Maximum |

number of LTM candidate cells plus 1

| | |
|---|---|
| ltm-SecurityGroupConfigToAddModList | SEQUENCE |

(SIZE (1.. maxNrofLTM-Configs-r18-plus-1) OF LTM-SecurityGroupConfig
OPTIONAL,

| | |
|---|---|
| ltm-SecurityGroupConfigToReleaseList | SEQUENCE |
| (SIZE (1.. maxNrofLTM-Configs-r18-plus-1) OF LTM-SecurityGroupID | OPTIONAL, |

```
    ...
  }
```

| | |
|---|---|
| LTM-SecurityGroupConfigToAddMod ::= | SEQUENCE { |
| ltm-SecurityGroupId-r18 | Ltm-SecurityGroupId, |
| nextHopChainingCount | NextHopChainingCount |
| ltm-cs-CounterList-r18 | /// either [a list of Ltm-cs-Counters] or [a first |
| ltm-cs-Counter + numeber of ltm-cs-Counter] | OPTIONAL |

}

| | |
|---|---|
| Ltm-cs-Counters ::= | INTEGER (0..65535) |
| LTM-SecurityGroupId ::= | Integer (1.. maxNrofLTM-Configs-r18-plus-1) |
| maxNrofLTM-Configs-r18-plus-1 | INTEGER ::= 9 -- Maximum |

number of LTM candidate cells plus 1

ltm-SecurityGroupId: This field is used by the UE to determine on whether security update (or PDCP/RLC re-establishment) should be performed when an LTM cell switch procedure is triggered towards an LTM candidate cell.

nextHopChainingCount: Parameter NCC associated with the LTM security group (ID):

The IE Ltm-CS-Counter is a counter used upon refresh of K_GNB based on the current or newly derived K_GNB during LTM cell switch.

ltm-SecurityCellSetId: This field is used by the UE to determine on whether security update (or PDCP/RLC re-establishment) should be performed when an LTM cell switch procedure is triggered towards an LTM candidate cell.

Base station configures either ltm-SecurityCellSetId field or ltm-ServingCellNoResetID field but not both.

If ltm-SecurityCellSetId is present, UE determines, based on this field, whether PDCP/RLC re-establishment should be performed when an LTM cell switch procedure is triggered towards an LTM candidate cell.

If ltm-ServingCellNoResetID is present, UE determines, based on this field, whether RLC re-establishment should be performed when an LTM cell switch procedure is triggered towards an LTM candidate cell. UE does not perform PDCP re-establishment.

### KgNB (K_gNB), KRRCenc (K_RRC_enc), KUPenc (K_UP_enc), KRRCint (K_RRC_int), KUPint (K_UP_int)

Security Update/Security key update means:
>: new K_gNB is derived from current K_gNB and other inputs (e.g. COUNT, ARFCN, PCI etc) or from NH and other inputs (e.g. ARFCN, PCI etc).
>: new K_RRC_enc, new K_RRC_int, new K_UP_enc and new K_UP_int are derived from the new K_gNB.

Handover procedure and Cell Switch procedure are procedure for cell level mobility.

Handover procedure and Cell Switch procedure are procedure for network-controlled mobility.

Handover procedure is a procedure for cell level mobility (network-controlled mobility) triggered by reception of RRCReconfiguration message.

Cell Switch procedure is a procedure for cell level mobility (network-controlled mobility) triggered by reception of LTM Cell Switch Command MAC CE.

In the Cell Switch procedure, source/serving cell is the PCell when LTM Cell Switch Command MAC CE is received.

Target/candidate cell is the PCell associated with the Target Configuration ID of the LTM Cell Switch Command MAC CE. Configuration of Target/candidate cell is indicated by SpCellConfig IE within ltm-CandidateConfig/RRCReconfiguration of LTM-candidate IE that is associated with Target Configuration ID.

PCI of Target/candidate cell is indicated twice in LTM-candidate IE; one in ltm-CandidatePCI field and one in physCellId field in spCellConfigCommon. This is to facilitate fast downlink synchronization (UE can identify PCI of the cell for downlink synchronization without checking inside of RRCReconfiguration)

In the disclosure, if not stated otherwise:
>: the LTM-Candidate (IE) in VarLTM-Config indicated by lower layers is the LTM-Candidate of which ltm-CandidateId is equal to Target Configuration ID plus 1.
>: Target Configuration ID in the MAC CE indicates LTM-Candidate IE of which ltm-CandidateId is equal to Target Configuration ID plus 1.

LTM-Config-r18 ::= SEQUENCE {

| | |
|---|---|
| ltm-ReferenceConfiguration-r18 | SetupRelease |
| {ReferenceConfiguration-r18} | OPTIONAL, -- Need |

M

| | |
|---|---|
| ltm-CandidateToReleaseList-r18 | SEQUENCE (SIZE |
| (1..maxNrofLTM-Configs-r18)) OF LTM-CandidateId-r18 | OPTIONAL, -- Need N |
| ltm-CandidateToAddModList-r18 | SEQUENCE (SIZE |
| (1..maxNrofLTM-Configs-r18)) OF LTM-Candidate-r18 | OPTIONAL, -- Need N |
| ltm-ServingCellNoResetID-r18 | INTEGER (1..maxNrofLTM- |
| Configs-r18-plus-1) | OPTIONAL, -- Cond FirstLTM-Only |
| ltm-CSI-ResourceConfigToAddModList-r18 | SEQUENCE (SIZE |

(1..maxNrofLTM-CSI-ResourceConfigurations-r18)) OF LTM-CSI-ResourceConfig-r18
OPTIONAL, -- Need N

| | |
|---|---|
| ltm-CSI-ResourceConfigToReleaseList-r18 | SEQUENCE (SIZE |

(1..maxNrofLTM-CSI-ResourceConfigurations-r18)) OF LTM-CSI-ResourceConfigId-r18
OPTIONAL, -- Need N

| | |
|---|---|
| attemptLTM-Switch-r18 | ENUMERATED {true} |

OPTIONAL, -- Cond LTM-MCG

| | |
|---|---|
| ltm-ServingCellUE-MeasuredTA-ID-r18 | INTEGER (1..maxNrofLTM- |
| Configs-r18-plus-1) | OPTIONAL, -- Cond LTM |
| ltm-SecurityCellSetID | INTEGER (1..maxNrofLTM- |
| Configs-r18-plus-1) | OPTIONAL, |
| drb-ContinueRohcID | INTEGER (1..maxNrofLTM- |
| Configs-r18-plus-1) | OPTIONAL, |

```
    ...
  }
```

| | |
|---|---|
| maxNrofLTM-Configs-r18-plus-1 | INTEGER ::= 9 -- Maximum |

number of LTM candidate cells plus 1

drb-ContinueRohcID: This field is used by the UE to determine on whether ROHC reset should be performed when an LTM cell switch procedure is triggered towards an LTM candidate cell.

### ROHC Reset Operation

When ROHC reset operation is triggered/performed due to handover:
>: The transmitting PDCP entity reset ROHC protocol for uplink for a specific set of DRBs and start with an IR state in U-mode.
   >>: The specific set of DRBs are UM DRBs and AM DRBs that are not configured with drb-ContinueROHC field in the associated PDCP-Config IE.
>: The transmitting PDCP entity continue ROHC protocol for uplink for a second specific set of DRBs.
   >>: The second specific set of DRBs are UM DRBs and AM DRBs that are configured with drb-ContinueROHC field in the associated PDCP-Config IE.
>: The transmitting PDCP entity performs header compression of specific set of PDCP SDUs using ROHC protocol after ROHC protocol reset.
   >>: The specific set of PDCP SDUs are PDCP SDUs for which the successful delivery of the corresponding PDCP Data PDU has not been confirmed by lower layers (e.g. PDCP Data PDUs for which positive RLC acknowledgement have not been received)
>: The receiving PDCP entity performs header decompression for a specific set of AM DRBs using ROHC for all stored PDCP SDUs.
   >>: The specific set of AM DRBs are AM DRBs that are configured with drb-ContinueROHC field in the associated PDCP-Config IE.
>: The receiving PDCP entity reset ROHC protocol for downlink for the specific set of DRBs and start with NC state in U-mode.

When ROHC reset operation is triggered/performed due to LTM Cell Switch:
>: The transmitting PDCP entity reset ROHC protocol for uplink for a specific set of DRBs and start with an IR state in U-mode.
   >>: The specific set of DRBs are UM DRBs and AM DRBs that are configured with ROHC and are part of current UE configuration when LTM Cell Switch MAC CE is received
>: The transmitting PDCP entity performs header compression of specific set of PDCP SDUs using ROHC protocol after ROHC protocol reset.
   >>: The specific set of PDCP SDUs are PDCP SDUs:
      >>>: for which the successful delivery of the corresponding PDCP Data PDU has not been confirmed by lower layers (e.g. PDCP Data PDUs for which positive RLC acknowledgement have not been received); and
      >>>: belongs to AM DRBs that are configured with ROHC and part of current UE configuration.
>: The receiving PDCP entity performs header decompression for a specific set of AM DRBs using ROHC for all stored PDCP SDUs.
   >>: The specific set of AM DRBs are AM DRBs that are configured with ROHC and are part of current UE configuration when LTM Cell Switch MAC CE is received.
>: The receiving PDCP entity reset ROHC protocol for downlink for the specific set of DRBs and start with NC state in U-mode.

DRB that is configured with ROHC=DRB of which PDCP-config includes rohc field or uplinkOnlyROHC field.

LTM-Config-r18 ::= SEQUENCE {

| | |
|---|---|
| ltm-ReferenceConfiguration-r18 | SetupRelease |
| {ReferenceConfiguration-r18} | OPTIONAL, -- Need |

M

| | |
|---|---|
| ltm-CandidateToReleaseList-r18 | SEQUENCE (SIZE |
| (1..maxNrofLTM-Configs-r18)) OF LTM-CandidateId-r18 | OPTIONAL, -- Need N |
| ltm-CandidateToAddModList-r18 | SEQUENCE (SIZE |
| (1..maxNrofLTM-Configs-r18)) OF LTM-Candidate-r18 | OPTIONAL, -- Need N |
| ltm-ServingCellNoResetID-r18 | INTEGER (1..maxNrofLTM- |
| Configs-r18-plus-1) | OPTIONAL, -- Cond FirstLTM-Only |
| ltm-CSI-ResourceConfigToAddModList-r18 | SEQUENCE (SIZE |

(1..maxNrofLTM-CSI-ResourceConfigurations-r18)) OF LTM-CSI-ResourceConfig-r18
OPTIONAL, -- Need N

| | |
|---|---|
| ltm-CSI-ResourceConfigToReleaseList-r18 | SEQUENCE (SIZE |

(1..maxNrofLTM-CSI-ResourceConfigurations-r18)) OF LTM-CSI-ResourceConfigId-r18
OPTIONAL, -- Need N

| | |
|---|---|
| attemptLTM-Switch-r18 | ENUMERATED {true} |

OPTIONAL, -- Cond LTM-MCG

| | |
|---|---|
| ltm-ServingCellUE-MeasuredTA-ID-r18 | INTEGER (1..maxNrofLTM- |
| Configs-r18-plus-1) | OPTIONAL, -- Cond LTM |
| ltm-SecurityCellSetID | INTEGER (1..maxNrofLTM-Configs- |
| r18-plus-1) | OPTIONAL, |
| drb-ContinueRohcID | INTEGER (1..maxNrofLTM- |
| Configs-r18-plus-1) | OPTIONAL, |
| drb-ContinueEHCID | INTEGER (1..maxNrofLTM- |
| Configs-r18-plus-1) | OPTIONAL, |

```
    ...
  }
```

| | |
|---|---|
| maxNrofLTM-Configs-r18-plus-1 | INTEGER ::= 9 -- Maximum |

number of LTM candidate cells plus 1

drb-ContinueEHCID: This field is used by the UE to determine on whether EHC reset should be performed when an LTM cell switch procedure is triggered towards an LTM candidate cell.

### EHC Reset Operation

When EHC reset operation is triggered/performed due to handover:
>: The transmitting PDCP entity reset EHC protocol for uplink for a specific set of DRBs.
   >>: The specific set of DRBs are UM DRBs and AM DRBs that are not configured with drb-ContinueEHC-UL field in the associated PDCP-Config IE.
>: The transmitting PDCP entity continue EHC protocol for uplink for a second specific set of DRBs.
   >>: The second specific set of AM DRBs are AM DRBs that are configured with drb-ContinueEHC-UL field in the associated PDCP-Config IE.
>: The transmitting PDCP entity performs header compression of specific set of PDCP SDUs using EHC protocol after EHC protocol reset.
   >>: The specific set of PDCP SDUs are PDCP SDUs:
      >>>: That are stored in the buffer of a third specific set of AM DRBs; and
      >>>: for which the successful delivery of the corresponding PDCP Data PDU has not been confirmed by lower layers (e.g. PDCP Data PDUs for which positive RLC acknowledgement have not been received).
   >>: The third specific set of AM DRBs are AM DRBs that are configured with drb-ConftinueEHC-UL field in the associated PDCP-Config IE
>: The receiving PDCP entity performs header decompression for the fourth specific set of AM DRBs using EHC for all stored PDCP SDUs.
>: The receiving PDCP entity reset EHC protocol for downlink for the fourth specific set of DRBs.
>: The fourth specific set of DRBs are UM DRBs and AM DRBs that are configured with drb-ContinueEHC-DL field in the associated PDCP-Config IE.

When ROHC reset operation is triggered/performed due to LTM Cell Switch:
>: The transmitting PDCP entity reset EHC protocol for uplink for a specific set of DRBs.
>: The transmitting PDCP entity performs header compression of specific set of PDCP SDUs using EHC protocol after EHC protocol reset.
   >>: The specific set of PDCP SDUs are PDCP SDUs:
      >>>: for which the successful delivery of the corresponding PDCP Data PDU has not been confirmed by lower layers (e.g. PDCP Data PDUs for which positive RLC acknowledgement have not been received); and
      >>>: belongs to AM DRBs that are configured with EHC and part of current UE configuration.
>: The receiving PDCP entity perform header decompression for a specific set of AM DRBs using EHC for all stored PDCP SDUs.
>: The receiving PDCP entity reset EHC protocol for downlink for the specific set of DRBs.
>: The specific set of DRBs are UM DRBs and AM DRBs that are configured with EHC and are part of current UE configuration when LTM Cell Switch MAC CE is received.
>: The specific set of AM DRBs are AM DRBs that are configured with EHC and are part of current UE configuration when LTM Cell Switch MAC CE is received.

DRB that is configured with EHC=DRB of which PDCP-config includes EthernetHeaderCompression.

### LTM Configuration and Execution

The network configures the UE with one or more LTM candidate configurations within the LTM-Config IE.

The UE shall perform the following actions based on the received LTM-Config IE:
>: if the received LTM-Config includes ltm-ReferenceConfiguration set to setup:
   >>: if the current VarLTM-Config includes an ltm-ReferenceConfiguration:
      >>>: replace the ltm-Reference Configuration value within VarLTM-Config with the received ltm-ReferenceConfiguration;
   >>: else:
      >>>: store the received ltm-ReferenceConfiguration in VarLTM-Config;
>: else (the received LTM-Config includes ltm-ReferenceConfiguration set to release):
   >>: remove ltm-ReferenceConfiguration in VarLTM-Config;
>: if the received LTM-Config includes ltm-ServingCellNoResetID:
   >>: if the current VarLTM-ServingCellNoResetID includes an ltm-ServingCellNoResetID:
      >>>: replace the ltm-ServingCellNoResetID value within VarLTM-ServingCellNoResetID with the received ltm-ServingCellNoResetID;
   >>: else:
      >>>: store the received ltm-ServingCellNoResetID in VarLTM-ServingCellNoResetID;
>: if the received LTM-Config includes ltm-ServingCellUE-MeasuredTA-ID:
   >>: if the current VarLTM-ServingCellUE-MeasuredTA-ID includes an ltm-ServingCellUE-MeasuredTA-ID:
      >>>: replace the ltm-ServingCellUE-MeasuredTA-ID value within VarLTM-ServingCellUE-MeasuredTA-ID with the received ltm-ServingCellUE-MeasuredTA-ID;
   >>: else:
      >>>: store the received ltm-ServingCellUE-MeasuredTA-ID in VarLTM-ServingCellUE-MeasuredTA-ID;
>: if the received LTM-Config includes ltm-SecurityCellSetId:
   >>: if the current VarLTM-SecurityCellSetId includes an ltm-SecurityCellSetId:
      >>>: replace the ltm-SecurityCellSetId value within VarLTM-SecurityCellSetId with the received ltm-SecurityCellSetId;
   >>: else:
      >>>: store the received ltm-SecurityCellSetId in VarLTM-SecurityCellSetId;
>: for each ltm-CandidateId value included in the ltm-CandidateToReleaseList for which there is an entry in ltm-CandidateList in VarLTM-Config:
   >>: The UE shall remove the entry related to LTM-Candidate from VarLTM-Config.
>: for each ltm-CandidateId value in the ltm-CandidateToAddModList:
   >>: if the current VarLTM-Config includes an LTM-Candidate with the ltm-CandidateId value:
      >>>: The UE shall replace the LTM-Candidate within VarLTM-Config in accordance with the received LTM-Candidate;
   >>: else:
      >>>: The UE shall add the received LTM-Candidate to VarLTM-Config;
   >>: if the LTM-Candidate with the received ltm-CandidateId value includes ltm-UE-MeasuredTA-ID:
      >>>: if the value of ltm-UE-MeasuredTA-ID is equal to the value of ltm-ServingCellUE-MeasuredTA-ID within VarLTM-ServingCellUE-MeasuredTA-ID:
         >>>>: The UE shall inform lower layers that UE is configured with UE-based TA measurements if an LTM cell switch is executed for this LTM

Upon the indication by lower layers that an LTM cell switch procedure is triggered, or upon performing LTM cell switch following cell selection performed while timer T311 was running:
>: The UE shall release/clear all current common radio configuration associated with the cell group for which the LTM cell switch procedure is triggered;
>: The UE shall use the default values for timers T310, T311 and constants N310, N311 associate to cell group for which the LTM cell switch procedure is triggered;
>: if the value of field ltm-NoResetID contained within the LTM-Candidate IE in VarLTM-Config indicated by lower layers or for the selected cell is not equal to the value of ltm-ServingCellNoResetID within VarLTM-ServingCellNoResetID:
   >>: for each logicalChannelId and logicalChannelIdExt that is part of the current UE configuration for the cell group for which the LTM cell switch procedure is triggered:
      >>>: after the end of this procedure, re-establish the corresponding RLC entity, after applying the LTM configuration in ltm-CandidateConfig within LTM-Candidate IE in VarLTM-Config;
   >>: for each drb-Identity value that is part of the current UE configuration:
      >>>: if this DRB is an AM DRB:
         >>>>: after the end of this procedure, trigger the PDCP entity of this DRB to perform data recovery, after applying the LTM configuration in ltm-CandidateConfig within LTM-Candidate IE in VarLTM-Config;
   >>: replace the value of ltm-ServingCellNoResetID in VarLTM-ServingCellNoResetID with the value of ltm-NoResetID in the LTM-Candidate in VarLTM-Config indicated by lower layers or for the selected cell;
>: if the value of field Ltm-securityCellSetId contained within the LTM-Candidate IE in VarLTM-Config indicated by lower layers or for the selected cell is not equal to the value of Ltm-securityCellSetId within VarLtm-securityCellSetId:
   >>: for each drb-Identity and srb-Identity that is part of the current UE configuration for the cell group for which the LTM cell switch procedure is triggered:
      >>>: after the end of this procedure, re-establish the corresponding PDCP entity, after applying the LTM configuration in ltm-CandidateConfig within LTM-Candidate IE in VarLTM-Config;
   >>: replace the value of Ltm-securityCellSetId in VarLtm-securityCellSetId with the value of Ltm-securityCellSetId in the LTM-Candidate in VarLTM-Config indicated by lower layers or for the selected cell;

When the UE considers the reference configuration to be the current UE configuration, the UE should store fields and configurations that are part of the reference configuration but should not execute any actions or procedures triggered by the reception of an RRCReconfiguration message.
>: if the LTM cell switch is triggered by an indication from lower layers:
   >>: apply the RRCReconfiguration message in ltm-CandidateConfig within LTM-Candidate IE in VarLTM-Config identified by the LTM candidate configuration identity received from lower layers;
>: else (LTM cell switch triggered upon cell selection performed while timer T311 was running):
   >>: apply the RRCReconfiguration message in ltm-CandidateConfig within LTM-Candidate IE in VarLTM-Config related to the LTM candidate configuration identity for the selected cell;
>: release the radio bearer(s) and the logical channel(s) that are part of the current UE configuration but not part of the LTM candidate configuration either indicated by lower layers or for the selected cell in accordance with 5.3.7.3, or the LTM reference configuration (in case the LTM candidate configuration does not include ltm-ConfigComplete).

When ltm-ConfigComplete is not included for an LTM candidate configuration, before an LTM cell switch is triggered a UE implementation may generate and store an RRC reconfiguration message by applying the received LTM candidate configuration on top of the LTM reference configuration, and the stored RRC reconfiguration message is applied when the LTM cell switch is triggered.

When upper layers request a PDCP entity re-establishment, the UE shall additionally perform once the procedures described in this clause for Uu or PC5 interface.

When upper layers request a PDCP entity re-establishment, the transmitting PDCP entity shall:
>: for UM DRBs and AM DRBs, reset the ROHC protocol for uplink and start with an IR state in U-mode (as defined in RFC 3095 [8] and RFC 4815 [9]) if drb-ContinueROHC is not configured in TS 38.331 [3];
>: for UM DRBs and AM DRBs, reset the EHC protocol for uplink if drb-ContinueEHC-UL is not configured;
>: for AM DRBs, reset the UDC compression buffer to all zeros and prefill the dictionary if drb-ContinueUDC;
>: for SRBs and UM DRBs, set TX_NEXT to the initial value;
>: for SRBs, discard all stored PDCP SDUs and PDCP PDUs;
>: apply the ciphering algorithm and key provided by upper layers during the PDCP entity re-establishment procedure;
>: apply the integrity protection algorithm and key provided by upper layers during the PDCP entity re-establishment procedure;
>: for UM DRBs, for each PDCP SDU already associated with a PDCP SN but for which a corresponding PDU has not previously been submitted to lower layers, and;
>: for AM DRBs for Uu interface whose PDCP entities were suspended, from the first PDCP SDU for which the successful delivery of the corresponding PDCP Data PDU has not been confirmed by lower layers, for each PDCP SDU already associated with a PDCP SN:
   >>: UE consider the PDCP SDUs as received from upper layer;
   >>: UE perform transmission of the PDCP SDUs in ascending order of the COUNT value associated to the PDCP SDU prior to the PDCP re-establishment without restarting the discardTimer or the discardTimerForLowImportance, as specified in clause 5.2.1;
>: for AM DRBs whose PDCP entities were not suspended, from the first PDCP SDU for which the successful delivery of the corresponding PDCP Data PDU has not been confirmed by lower layers, perform retransmission or transmission of all the PDCP SDUs already associated with PDCP SNs in ascending order of the COUNT values associated to the PDCP SDU prior to the PDCP entity re-establishment as specified below:
   >>: UE perform header compression of the PDCP SDU using ROHC and/or using EHC;
   >>: If drb-ContinueUDC is configured and if the PDCP SDU has been compressed before:
      >>>: UE submit the PDCP SDU previously compressed to integrity protection and ciphering function;
   >>: else:
      >>>: UE performs uplink data compression of the PDCP SDU as specified in clause 5.14.4, and submit the PDCP SDU to integrity protection and ciphering function;
   >>: UE perform integrity protection and ciphering of the PDCP SDU using the COUNT value associated with this PDCP SDU as specified in the clause 5.9 and 5.8;
   >>: UE submit the resulting PDCP Data PDU to lower layer, as specified in clause 5.2.1.

When upper layers request a PDCP entity re-establishment:
>: UE shall process the PDCP Data PDUs that are received from lower layers due to the re-establishment of the lower layers;
>: for SRBs, UE shall discard all stored PDCP SDUs and PDCP PDUs;
>: for SRBs, UM DRBs and UM MRBs, if t-Reordering is running:
   >>: UE shall stop and reset t-Reordering;
   >>: for UM DRBs and UM MRBs, UE shall deliver all stored PDCP SDUs to the upper layers in ascending order of associated COUNT values after performing header decompression;
>: for AM DRBs and AM MRBs for Uu interface, UE shall perform header decompression using ROHC for all stored PDCP SDUs if drb-ContinueROHC is not configured;
>: for AM DRBs for PC5 interface, UE shall perform header decompression using ROHC for all stored PDCP IP SDUs;
>: for AM DRBs and AM MRBs for Uu interface, UE shall perform header decompression using EHC for all stored PDCP SDUs if drb-ContinueEHC-DL is not configured in TS 38.331 [3];
>: for UM DRBs, AM DRBs, UM MRBs and AM MRBs, UE shall reset the ROHC protocol for downlink and start with NC state in U-mode (as defined in RFC 3095 [8] and RFC 4815 [9]) if drb-ContinueROHC is not configured in TS 38.331 [3];
>: for UM DRBs, AM DRBs, UM MRBs and AM MRBs, UE shall reset the EHC protocol for downlink if drb-ContinueEHC-DL is not configured in TS 38.331 [3];
>: for SRBs and UM DRBs, UE shall set RX_NEXT and RX_DELIV to the initial value;
>: for UM MRBs and AM MRBs, UE shall set RX_NEXT and RX_DELIV to the initial value if initialRX-DELIV is configured;
>: UE shall apply the ciphering algorithm and key provided by upper layers during the PDCP entity re-establishment procedure;
>: UE shall apply the integrity protection algorithm and key provided by upper layers during the PDCP entity re-establishment procedure.

### Data Recovery

For AM DRBs, when upper layers request a PDCP data recovery for a radio bearer, the transmitting PDCP entity shall:
>: perform retransmission of all the PDCP Data PDUs previously submitted to re-established or released AM RLC entities in ascending order of the associated COUNT values for which the successful delivery has not been confirmed by lower layers, following the data submission procedure.

ROHC is defined for the ROHC framework. Each profile is specific to the particular network layer, transport layer or upper layer protocol combination e.g. TCP/IP and RTP/UDP/IP.

The detailed definition of the ROHC channel is specified as part of the ROHC framework defined in RFC 5795. This includes how to multiplex different flows (header compressed or not) over the ROHC channel, as well as how to associate a specific IP flow with a specific context state during initialization of the compression algorithm for that flow.

The implementation of the functionality of the ROHC framework and of the functionality of the supported header compression profiles is not covered in this specification.

PDCP entities associated with DRBs and MRBs can be configured by upper layers to use ROHC. Each PDCP entity carrying user plane data may be configured to use ROHC. PDCP entities associated with sidelink DRBs can be configured to use ROHC for IP SDUs. For DRBs and MRBs other than DAPS bearers, the PDCP entity uses at most one ROHC compressor instance and at most one ROHC decompressor instance. For DAPS bearers, the PDCP entity uses at most one ROHC compressor instance (i.e. use the ROHC compressor instance for source cell before uplink data switching, and use the ROHC compressor instance for target cell after uplink data switching) and at most two ROHC decompressor instances.

The EHC protocol is based on the Ethernet Header Compression (EHC) framework.

PDCP entities associated with DRBs and MRBs can be configured by upper layers to use EHC. Each PDCP entity carrying user plane data may be configured to use EHC. Every PDCP entity uses at most one EHC compressor instance and at most one EHC decompressor instance.

### RLC Re-Establishment

When upper layers request an RLC entity re-establishment, the UE shall:
>: discard all RLC SDUs, RLC SDU segments, and RLC PDUs, if any;
>: stop and reset all timers;
>: reset all state variables to their initial values.

The RRCReconfiguration message is the command to modify an RRC connection. It may convey information for measurement configuration, mobility control, radio resource configuration (including RBs, MAC main configuration and physical channel configuration) and AS security configuration.

```
  -- ASN1START
  -- TAG-RRCRECONFIGURATION-START
```

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-IEs, |
| criticalExtensionsFuture | SEQUENCE { } |

```
    }
  }
```

| | |
|---|---|
| RRCReconfiguration-IEs ::= | SEQUENCE { |
| radioBearerConfig | RadioBearerConfig |

OPTIONAL, -- Need M

| | |
|---|---|
| secondaryCellGroup | OCTET STRING |
| (CONTAINING CellGroupConfig) | OPTIONAL, -- |

Cond SCG

| | |
|---|---|
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530- |
| IEs | OPTIONAL |

}

| | |
|---|---|
| RRCReconfiguration-v1530-IEs ::= | SEQUENCE { |
| masterCellGroup | OCTET STRING |
| (CONTAINING CellGroupConfig) | OPTIONAL, -- |

Need M

| | |
|---|---|
| fullConfig | ENUMERATED {true} |

OPTIONAL, -- Cond FullConfig

| | |
|---|---|
| dedicatedNAS-MessageList | SEQUENCE |
| (SIZE(1..maxDRB)) OF DedicatedNAS-Message | OPTIONAL, -- |

Cond nonHO

| | |
|---|---|
| masterKeyUpdate | MasterKeyUpdate |

OPTIONAL, -- Cond MasterKeyChange

| | |
|---|---|
| dedicatedSIB1-Delivery | OCTET STRING |
| (CONTAINING SIB1) | OPTIONAL, -- |

Need N

| | |
|---|---|
| dedicatedSystemInformationDelivery | OCTET STRING |
| (CONTAINING SystemInformation) | OPTIONAL, -- |

Need N

| | |
|---|---|
| otherConfig | OtherConfig |

OPTIONAL, -- Need M

| | |
|---|---|
| nonCriticalExtension | RRCReconfiguration-v1540- |
| IEs | OPTIONAL |

}

| | |
|---|---|
| RRCReconfiguration-v1800-IEs ::= | SEQUENCE { |
| needForInterruptionConfigNR-r18 | ENUMERATED { enabled, |
| disabled } | OPTIONAL, -- Need M |
| uav-Config-r18 | SetupRelease { UAV-Config- |
| r18 } | OPTIONAL, -- Need M |
| sl-IndirectPathAddChange-r18 | SetupRelease { SL- |
| IndirectPathAddChange-r18 } | OPTIONAL, -- Need M |
| n3c-IndirectPathAddChange-r18 | SetupRelease { N3C- |
| IndirectPathAddChange-r18 } | OPTIONAL, -- Need M |
| n3c-IndirectPathConfigRelay-r18 | SetupRelease { N3C- |
| IndirectPathConfigRelay-r18 } | OPTIONAL, -- Need M |
| otherConfig-v1800 | OtherConfig-v1800 |

OPTIONAL, -- Need M

| | |
|---|---|
| srs-PosResourceSetLinkedForAggBWList-r18 | SetupRelease { SRS- |
| PosResourceSetLinkedForAggBWList-r18 } | OPTIONAL, -- Need M |
| ltm-Config-r18 | SetupRelease { LTM-Config- |
| r18} | OPTIONAL, -- Need M |
| nonCriticalExtension | SEQUENCE { } |

OPTIONAL
}

| | |
|---|---|
| MasterKeyUpdate ::= | SEQUENCE { |
| keySetChangeIndicator | BOOLEAN, |
| nextHopChainingCount | NextHopChainingCount, |
| nas-Container | OCTET STRING |

OPTIONAL, -- Cond securityNASC

keySetChangeIndicator indicates whether UE shall derive a new K_{gNB}. If reconfigurationWithSync is included, value true indicates that a K_{gNB} key is derived from a K_{AMF} key taken into use through the latest successful NAS SMC procedure, or N2 handover procedure with K_{AMF} change, as described in TS 33.501 for K_{gNB} re-keying. Value false indicates that the new K_{gNB} key is obtained from the current K_{gNB} key or from the NH as described in TS 33.501 [11].
   nextHopChainingCount is Parameter NCC

MasterKeyChange This field is mandatory present in case masterCellGroup includes ReconfigurationWithSync and RadioBearerConfig includes SecurityConfig with SecurityAlgorithmConfig, indicating a change of the AS security algorithms associated to the master key. If ReconfigurationWithSync is included for other cases, this field is optionally present, need N. If Reconfiguration WithSync is part of an LTM-Candidate IE associated with the MCG, the field is absent. Otherwise the field is absent.

```
  The IE LTM-Config is used to provide LTM candidate configurations.
  -- ASN1START
  -- TAG-LTM-CONFIG-START
  LTM-Config-r18 ::= SEQUENCE {
```

| | |
|---|---|
| ltm-ReferenceConfiguration-r18 | SetupRelease |
| {ReferenceConfiguration-r18} | OPTIONAL, -- Need |

M

| | |
|---|---|
| ltm-CandidateToReleaseList-r18 | SEQUENCE (SIZE |
| (1..maxNrofLTM-Configs-r18)) OF LTM-CandidateId-r18 | OPTIONAL, -- Need N |
| ltm-CandidateToAddModList-r18 | SEQUENCE (SIZE |
| (1..maxNrofLTM-Configs-r18)) OF LTM-Candidate-r18 | OPTIONAL, -- Need N |
| ltm-ServingCellNoResetID-r18 | INTEGER (1..maxNrofLTM- |
| Configs-r18-plus-1) | OPTIONAL, -- Cond FirstLTM-Only |
| ltm-CSI-ResourceConfigToAddModList-r18 | SEQUENCE (SIZE |

(1..maxNrofLTM-CSI-ResourceConfigurations-r18)) OF LTM-CSI-ResourceConfig-r18
OPTIONAL, -- Need N

| | |
|---|---|
| ltm-CSI-ResourceConfigToReleaseList-r18 | SEQUENCE (SIZE |

(1..maxNrofLTM-CSI-ResourceConfigurations-r18)) OF LTM-CSI-ResourceConfigId-r18
OPTIONAL, -- Need N

| | |
|---|---|
| attemptLTM-Switch-r18 | ENUMERATED {true} |

OPTIONAL, -- Cond LTM-MCG

| | |
|---|---|
| ltm-ServingCellUE-MeasuredTA-ID-r18 | INTEGER (1..maxNrofLTM- |
| Configs-r18-plus-1) | OPTIONAL, -- Cond LTM |
| ltm-ServingSecurityCellSetID-r18 | INTEGER (1..maxNrofLTM- |

```
Configs-r18-plus-1)
    ...
  }
  -- TAG-LTM-CONFIG-STOP
  -- ASN1STOP
```

For attemptLTM-Switch, if present, the UE shall execute an LTM cell switch if selected cell is a LTM candidate cell and it is the first cell selection after failure.

ltm-CandidateToAddModList is list of LTM candidate configurations to add and/or modify.

ltm-CandidateToReleaseList is list of LTM candidate configurations to remove.

ltm-ReferenceConfiguration includes an RRCReconfiguration message used to configure a reference configuration for LTM.

ltm-ServingCellNoResetID field is used by the UE to determine on whether L2 reset should be performed when an LTM cell switch procedure is triggered towards an LTM candidate cell.

ltm-ServingSecurityCellSetID field is used by the UE to determine on whether PDCP/security reset4 should be performed when an LTM cell switch procedure is triggered towards an LTM candidate cell.

The IE LTM-Candidate concerns a LTM candidate configuration to add or modify.

```
  -- ASN1START
  -- TAG-LTM-CANDIDATE-START
```

| | |
|---|---|
| LTM-Candidate-r18 ::= | SEQUENCE { |

| | |
|---|---|
| ltm-CandidateId-r18 | LTM-CandidateId- |

r18,

| | |
|---|---|
| ltm-CandidatePCI-r18 | PhysCellId, |
| ltm-SSB-Config-r18 | LTM-SSB-Config- |

| | |
|---|---|
| r18 | OPTIONAL, -- Need M |

| | |
|---|---|
| ltm-CandidateConfig-r18 | OCTET STRING |

| | |
|---|---|
| (CONTAINING RRCReconfiguration) | OPTIONAL, -- Need M |

| | |
|---|---|
| ltm-ConfigComplete-r18 | ENUMERATED |

| | |
|---|---|
| {true} | OPTIONAL, -- Need R |

| | |
|---|---|
| ltm-EarlyUL-SyncConfig-r18 | SetupRelease { |

| | |
|---|---|
| EarlyUL-SyncConfig-r18 } | OPTIONAL, -- Need M |

| | |
|---|---|
| ltm-EarlyUL-SyncConfigSUL-r18 | SetupRelease { |

| | |
|---|---|
| EarlyUL-SyncConfig-r18 } | OPTIONAL, -- Need M |

| | |
|---|---|
| ltm-NoResetID-r18 | INTEGER |

| | |
|---|---|
| (1..maxNrofLTM-Configs-r18-plus-1) | OPTIONAL, -- Need M |

| | |
|---|---|
| ltm-DL-OrJointTCI-StateToAddModList-r18 | SEQUENCE (SIZE |

(1..maxNrofCandidateTCI-State-r18)) OF CandidateTCI-State-r18
OPTIONAL, -- Need N

| | |
|---|---|
| ltm-DL-OrJointTCI-StateToReleaseList-r18 | SEQUENCE (SIZE |

(1..maxNrofCandidateTCI-State-r18)) OF TCI-StateId
OPTIONAL, -- Need N

| | |
|---|---|
| ltm-UL-TCI-StatesToAddModList-r18 | SEQUENCE (SIZE |

(1..maxNrofCandidateUL-TCI-r18)) OF CandidateTCI-UL-State-r18
OPTIONAL, -- Need N

| | |
|---|---|
| ltm-UL-TCI-StatesToReleaseList-r18 | SEQUENCE (SIZE (1.. |

maxNrofCandidateUL-TCI-r18)) OF TCI-UL-StateId-r17
OPTIONAL, -- Need N

| | |
|---|---|
| ltm-nzp-CSI-RS-ResourceToAddModList-r18 | SEQUENCE (SIZE |

(1..maxNrofNZP-CSI-RS-Resources)) OF NZP-CSI-RS-Resource
OPTIONAL, -- Need N

| | |
|---|---|
| ltm-nzp-CSI-RS-ResourceToReleaseList-r18 | SEQUENCE (SIZE |

(1..maxNrofNZP-CSI-RS-Resources)) OF NZP-CSI-RS-ResourceId
OPTIONAL, -- Need N

| | |
|---|---|
| ltm-nzp-CSI-RS-ResourceSetToAddModList-r18 | SEQUENCE (SIZE |

(1..maxNrofNZP-CSI-RS-ResourceSets)) OF NZP-CSI-RS-ResourceSet
OPTIONAL, -- Need N

| | |
|---|---|
| ltm-nzp-CSI-RS-ResourceSetToReleaseList-r18 | SEQUENCE (SIZE |

(1..maxNrofNZP-CSI-RS-ResourceSets)) OF NZP-CSI-RS-ResourceSetId
OPTIONAL, -- Need N

| | |
|---|---|
| pathlossReferenceRS-ToAddModList-r18 | SEQUENCE (SIZE |

(1..maxNrofPathlossReferenceRSs-r17)) OF PathlossReferenceRS-r17
OPTIONAL, -- Need N

| | |
|---|---|
| pathlossReferenceRS-ToReleaseList-r18 | SEQUENCE (SIZE |

(1..maxNrofPathlossReferenceRSs-r17)) OF PathlossReferenceRS-Id-r17
OPTIONAL, -- Need N

| | |
|---|---|
| ltm-UE-MeasuredTA-ID-r18 | INTEGER |

| | |
|---|---|
| (1..maxNrofLTM-Configs-r18-plus-1) | OPTIONAL, -- Need M |

| | |
|---|---|
| ltm-ServingSecurityCellSetID | INTEGER |

```
(1..maxNrofLTM-Configs-r18-plus-1)
    ...
  }
  LTM-SSB-Config-r18 ::= SEQUENCE {
```

| | |
|---|---|
| ssbFrequency-r18 | ARFCN-ValueNR, |
| subcarrierSpacing-r18 | SubcarrierSpacing, |
| ssb-Periodicity-r18 | ENUMERATED {ms5, |

ms10, ms20, ms40, ms80, ms160, spare2, spare1 } OPTIONAL, -- Need R

| | |
|---|---|
| ssb-PositionsInBurst-r18 | CHOICE { |
| shortBitmap | BIT STRING |

(SIZE (4)),

| | |
|---|---|
| mediumBitmap | BIT STRING |

(SIZE (8)),

| | |
|---|---|
| longBitmap | BIT STRING |

(SIZE (64))
}
OPTIONAL, -- Need R

| | |
|---|---|
| ss-PBCH-BlockPower-r18 | INTEGER (−60..50) |

```
OPTIONAL, -- Need R
    ...
  }
  -- TAG-LTM-CANDIDATE-STOP
  -- ASN1STOP
```

ltm-CandidateConfig includes an RRCReconfiguration message used to configure an LTM candidate cell.

ltm-CandidateId indicates an LTM candidate configuration.

ltm-CandidatePCI identifies the PCI of the SpCell of the configuration contained in ltm-CandidateConfig.

ltm-ConfigComplete indicates whether the LTM candidate configuration within ltm-CandidateConfig is a complete configuration.

ltm-SSB-Config indicates the configuration of SS/PBCH blocks to be used for L1 measurements configured with ltm-CSI-ReportConfigToAddModList in CSI-MeasConfig and for TCI states configured in other fields in LTM-Candidate.

ltm-UE-MeasuredTA-ID indicates whether the UE should perform UE-based TA measurements towards an LTM candidate.

ltm-NoResetID: This field is used to determine whether a L2 reset is required upon an LTM cell switch procedure. If the network configures this field for one LTM candidate configuration, this field should be also present in all LTM candidate configurations within ltm-CandidateToAddModList in LTM-Config. If this field is absent (or released) for at least one LTM candidate configuration, this field is also be absent (or released) in all LTM candidate configurations within ltm-CandidateToAddModList in LTM-Config.

ltm-UE-MeasuredTA-ID: This field is used to determine whether the UE is allowed to perform UE-based TA measurements. If the network configures this field for one LTM candidate configuration, this field should be also present in all LTM candidate configurations within ltm-CandidateToAddModList in LTM-Config. If this field is absent (or released) for at least one LTM candidate configuration, this field is also absent (or released) in all LTM candidate configurations within ltm-CandidateToAddModList in LTM-Config. This field is not present if ltm-CandidateConfig includes tag2 in ServingCellConfig for the SpCell.

ltm-SecurityGroupID: This field is used to determine whether a PDCP re-establishment (security update) is required upon an LTM cell switch procedure. If the network configures this field for one LTM candidate configuration, this field should be also present in all LTM candidate configurations within ltm-CandidateToAddModList in LTM-Config. If this field is absent (or released) for at least one LTM candidate configuration, this field is also absent (or released) in all LTM candidate configurations within ltm-CandidateToAddModList in LTM-Config.

Base station configures either ltm-SecurityGroupConfigToAddMod field or ltm-ServingCellNoResetID field but not both.

If ltm-SecurityGroupId is present, UE determines, based on this field, whether PDCP/RLC re-establishment should be performed when an LTM cell switch procedure is triggered towards an LTM candidate cell.

If ltm-ServingCellNoResetID is present, UE determines, based on this field, whether RLC re-establishment should be performed when an LTM cell switch procedure is triggered towards an LTM candidate cell. UE does not perform PDCP re-establishment.

The IE RadioBearerConfig is used to add, modify and release signalling, multicast MRBs and/or data radio bearers. Specifically, this IE carries the parameters for PDCP and, if applicable, SDAP entities for the radio bearers.

```
  -- ASN1START
  -- TAG-RADIOBEARERCONFIG-START
```

| | |
|---|---|
| RadioBearerConfig ::= | SEQUENCE { |
| srb-ToAddModList | SRB-ToAddModList |

OPTIONAL, -- Cond HO-Conn

| | |
|---|---|
| srb3-ToRelease | ENUMERATED{true} |

OPTIONAL, -- Need N

| | |
|---|---|
| drb-ToAddModList | DRB-ToAddModList |

OPTIONAL, -- Cond HO-toNR

| | |
|---|---|
| drb-ToReleaseList | DRB-ToReleaseList |

OPTIONAL, -- Need N

| | |
|---|---|
| securityConfig | SecurityConfig |

```
OPTIONAL, -- Need M
    ...,
    [[
```

| | |
|---|---|
| mrb-ToAddModList-r17 | MRB-ToAddModList-r17 |

OPTIONAL, -- Need N

| | |
|---|---|
| mrb-ToReleaseList-r17 | MRB-ToReleaseList-r17 |

OPTIONAL, -- Need N

| | |
|---|---|
| srb4-ToAddMod-r17 | SRB-ToAddMod |

OPTIONAL, -- Need N

| | |
|---|---|
| srb4-ToRelease-r17 | ENUMERATED{true} |

```
OPTIONAL -- Need N
    ]],
    [[
```

| | |
|---|---|
| srb5-ToAddMod-r18 | SRB-ToAddMod |

OPTIONAL, -- Need N

| | |
|---|---|
| srb5-ToRelease-r18 | ENUMERATED{true} |

```
OPTIONAL -- Need N
    ]]
  }
```

| | |
|---|---|
| SRB-ToAddModList ::= | SEQUENCE (SIZE (1..2)) OF |

SRB-ToAddMod

| | |
|---|---|
| SRB-ToAddMod ::= | SEQUENCE { |
| srb-Identity | SRB-Identity, |
| reestablishPDCP | ENUMERATED{true} |

OPTIONAL, -- Need N

| | |
|---|---|
| discardOnPDCP | ENUMERATED{true} |

OPTIONAL, -- Need N

| | |
|---|---|
| pdcp-Config | PDCP-Config |

```
OPTIONAL, -- Cond PDCP
    ...,
    [[
```

| | |
|---|---|
| srb-Identity-v1700 | SRB-Identity-v1700 |

```
OPTIONAL -- Need M
    ]],
    [[
```

| | |
|---|---|
| srb-Identity-v1800 | SRB-Identity-v1800 |

```
OPTIONAL -- Need M
    ]]
  }
```

| | |
|---|---|
| DRB-ToAddModList ::= | SEQUENCE (SIZE |

(1..maxDRB)) OF DRB-ToAddMod

| | |
|---|---|
| DRB-ToAddMod ::= | SEQUENCE { |
| cnAssociation | CHOICE { |
| eps-BearerIdentity | INTEGER (0..15), |
| sdap-Config | SDAP-Config |

}
OPTIONAL, -- Cond DRBSetup

| | |
|---|---|
| drb-Identity | DRB-Identity, |
| reestablishPDCP | ENUMERATED{true} |

OPTIONAL, -- Need N

| | |
|---|---|
| recoverPDCP | ENUMERATED{true} |

OPTIONAL, -- Need N

| | |
|---|---|
| pdcp-Config | PDCP-Config |

```
OPTIONAL, -- Cond PDCP
    ...,
    [[
```

| | |
|---|---|
| daps-Config-r16 | ENUMERATED{true} |

```
OPTIONAL -- Cond DAPS
    ]]
  }
```

| | |
|---|---|
| DRB-ToReleaseList ::= | SEQUENCE (SIZE (1..maxDRB)) |

OF DRB-Identity

| | |
|---|---|
| SecurityConfig ::= | SEQUENCE { |
| securityAlgorithmConfig | SecurityAlgorithmConfig |

OPTIONAL, -- Cond RBTermChange1

| | |
|---|---|
| keyToUse | ENUMERATED{master, |
| secondary} | OPTIONAL, -- Cond RBTermChange |

```
    ...
  }
```

securityConfig indicates the security algorithm and key to use for the signalling and data radio bearers configured with the list in this IE RadioBearerConfig.

securityAlgorithmConfig indicates the security algorithm for the signalling and data radio bearers configured with the list in this IE RadioBearerConfig. When the field is not included, the UE shall continue to use the currently configured security algorithm for the radio bearers reconfigured with the lists in this IE RadioBearerConfig.

The IE PDCP-Config is used to set the configurable PDCP parameters for signalling, MBS multicast and data radio bearers.

```
  -- ASN1START
  -- TAG-PDCP-CONFIG-START
```

| | |
|---|---|
| PDCP-Config ::= | SEQUENCE { |
| drb | SEQUENCE { |
| discardTimer | ENUMERATED {ms10, ms20, ms30, ms40, |

ms50, ms60, ms75, ms100, ms150, ms200,

| | |
|---|---|
| | ms250, ms300, ms500, |
| ms750, ms1500, infinity} OPTIONAL, -- Cond Setup | |
| pdcp-SN-SizeUL | ENUMERATED {len12bits, len18bits} |

OPTIONAL, -- Cond Setup1

| | |
|---|---|
| pdcp-SN-SizeDL | ENUMERATED {len12bits, len18bits} |

OPTIONAL, -- Cond Setup2

| | |
|---|---|
| headerCompression | CHOICE { |
| notUsed | NULL, |
| rohc | SEQUENCE { |
| maxCID | INTEGER (1..16383) |

DEFAULT 15,

| | |
|---|---|
| profiles | SEQUENCE { |
| profile0x0001 | BOOLEAN, |
| profile0x0002 | BOOLEAN, |
| profile0x0003 | BOOLEAN, |
| profile0x0004 | BOOLEAN, |
| profile0x0006 | BOOLEAN, |
| profile0x0101 | BOOLEAN, |
| profile0x0102 | BOOLEAN, |
| profile0x0103 | BOOLEAN, |
| profile0x0104 | BOOLEAN |

},

| | |
|---|---|
| drb-ContinueROHC | ENUMERATED { true } |

OPTIONAL -- Need N
},

| | |
|---|---|
| uplinkOnlyROHC | SEQUENCE { |
| maxCID | INTEGER (1..16383) |

DEFAULT 15,

| | |
|---|---|
| profiles | SEQUENCE { |
| profile0x0006 | BOOLEAN |

},

| | |
|---|---|
| drb-ContinueROHC | ENUMERATED { true } |

```
OPTIONAL -- Need N
        },
        ...
      },
```

| | |
|---|---|
| integrityProtection | ENUMERATED { enabled } |

OPTIONAL, -- Cond ConnectedTo5GC1

| | |
|---|---|
| statusReportRequired | ENUMERATED { true } |

OPTIONAL, -- Cond Rlc-AM-UM

| | |
|---|---|
| outOfOrderDelivery | ENUMERATED { true } |

OPTIONAL -- Need R
}
OPTIONAL, -- Cond DRB

| | |
|---|---|
| moreThanOneRLC | SEQUENCE { |
| primaryPath | SEQUENCE { |
| cellGroup | CellGroupId |

OPTIONAL, -- Need R

| | |
|---|---|
| logicalChannel | LogicalChannelIdentity |

OPTIONAL -- Need R
},

| | |
|---|---|
| ul-DataSplitThreshold | UL-DataSplitThreshold |

OPTIONAL, -- Cond SplitBearer

| | |
|---|---|
| pdcp-Duplication | BOOLEAN |

OPTIONAL -- Need R
}
OPTIONAL, -- Cond MoreThanOneRLC

| | |
|---|---|
| t-Reordering | ENUMERATED { |
| | ms0, ms1, ms2, ms4, ms5, ms8, ms10, |

ms15, ms20, ms30, ms40,

ms50, ms60, ms80, ms100, ms120,

ms140, ms160, ms180, ms200, ms220,

ms240, ms260, ms280, ms300,

ms500, ms750, ms1000, ms1250,

ms1500, ms1750, ms2000, ms2250,

ms2500, ms2750,

ms3000, spare28, spare27, spare26,

spare25, spare24,

```
        spare23, spare22, spare21, spare20,
        spare19, spare18, spare17, spare16,
```

spare15, spare14,

spare13, spare12, spare11, spare10,

spare09,

spare08, spare07, spare06, spare05,

spare04, spare03,

spare02, spare01 }

```
OPTIONAL, -- Need S
    ...,
    [[
```

| | |
|---|---|
| cipheringDisabled | ENUMERATED {true} |

```
OPTIONAL -- Cond ConnectedTo5GC
    ]],
    [[
```

| | |
|---|---|
| discardTimerExt-r16 | SetupRelease { DiscardTimerExt-r16 } |

OPTIONAL, -- Cond DRB2

| | |
|---|---|
| moreThanTwoRLC-DRB-r16 | SEQUENCE { |
| splitSecondaryPath-r16 | LogicalChannelIdentity |

OPTIONAL, -- Cond SplitBearer2

| | |
|---|---|
| duplicationState-r16 | SEQUENCE (SIZE (3)) OF BOOLEAN |

OPTIONAL -- Need S
}
OPTIONAL, -- Cond MoreThanTwoRLC-DRB

| | |
|---|---|
| ethernetHeaderCompression-r16 | SetupRelease { |
| EthernetHeaderCompression-r16 } | OPTIONAL -- Need M |

```
    ]],
    [[
```

| | |
|---|---|
| survivalTimeStateSupport-r17 | ENUMERATED {true} |

OPTIONAL, -- Cond Drb-Duplication

| | |
|---|---|
| uplinkDataCompression-r17 | SetupRelease { UplinkDataCompression- |

r17 } OPTIONAL, -- Cond Rlc-AM

| | |
|---|---|
| discardTimerExt2-r17 | SetupRelease { DiscardTimerExt2-r17 } |

OPTIONAL, -- Need M

| | |
|---|---|
| initialRX-DELIV-r17 | BIT STRING (SIZE (32)) |

```
OPTIONAL -- Cond MRB-Initialization
    ]],
    [[
```

| | |
|---|---|
| pdu-SetDiscard-r18 | ENUMERATED {true} |

OPTIONAL, -- Need R

| | |
|---|---|
| discardTimerForLowImportance-r18 | SetupRelease { |
| DiscardTimerForLowImportance-r18 } | OPTIONAL, -- Cond DRB2 |
| primaryPathOnIndirectPath-r18 | ENUMERATED {true} |

```
OPTIONAL -- Cond SplitBearerMP
    ]]
  }
```

| | |
|---|---|
| EthernetHeaderCompression-r16 ::= | SEQUENCE { |
| ehc-Common-r16 | SEQUENCE { |
| ehc-CID-Length-r16 | ENUMERATED { bits7, |

```
bits 15 },
        ...
    },
```

| | |
|---|---|
| ehc-Downlink-r16 | SEQUENCE { |
| drb-ContinueEHC-DL-r16 | ENUMERATED { true } |

```
OPTIONAL, -- Need N
      ...
    }
OPTIONAL, -- Need M
```

| | |
|---|---|
| ehc-Uplink-r16 | SEQUENCE { |
| maxCID-EHC-UL-r16 | INTEGER (1..32767), |
| drb-ContinueEHC-UL-r16 | ENUMERATED { true } |

```
OPTIONAL, -- Need N
      ...
    }
OPTIONAL -- Need M
  }
```

cipheringDisabled, if included, disables ciphering for this DRB regardless of which ciphering algorithm is configured for the SRB/DRBs.

discardTimer indicates value in ms of discardTimer. Value ms10 corresponds to 10 ms, value ms20 corresponds to 20 ms and so on.

drb-ContinueROHC indicates whether the PDCP entity continues or resets the ROHC header compression protocol during PDCP re-establishment.

ethernetHeaderCompression configures Ethernet Header Compression.

headerCompression, if rohc is configured, configures ROHC profile(s) in both uplink and downlink.

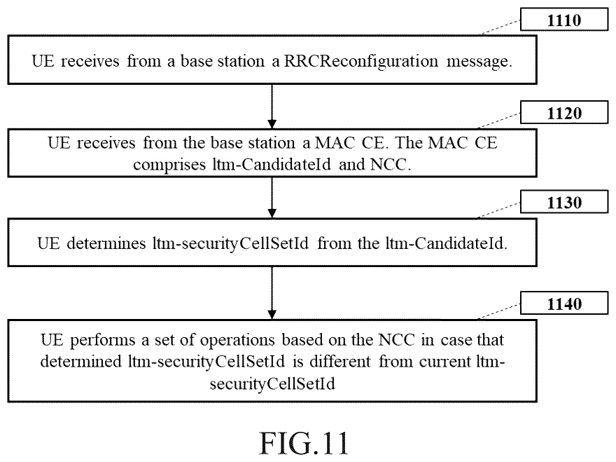

FIG. 11 illustrates operation of UE for cell switch.

At 1110, UE receives from a base station a RRCReconfiguration message. The RRCReconfiguration message comprises various parameters such as LTM-Config, RadioBearerConfig and likes.

At 1120, UE receives from the base station a MAC CE. The MAC CE comprises ltm-CandidateId and NCC.

At 1130, UE determines ltm-securityCellSetId from the ltm-CandidateId.

At 1140, UE performs a set of operations based on the NCC in case that determined ltm-securityCellSetId is different from current ltm-securityCellSetId.

The set of operation includes security key update, PDCP entity reestablishment, RLC entity reestablishment, ROHC reset and likes.

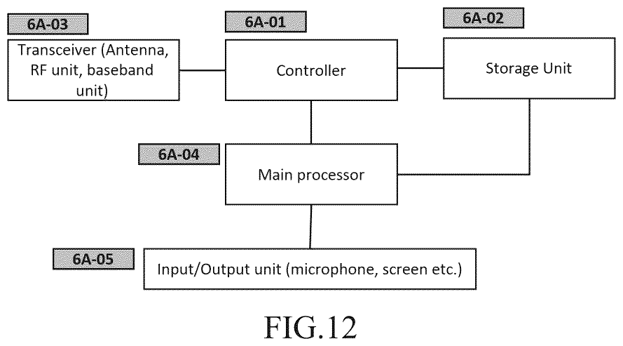

FIG. 12 is a block diagram illustrating the internal structure of a UE to which the disclosure is applied.

referring to the diagram, the UE includes a controller 6A-01, a storage unit 6A-02, a transceiver 6A-03, a main processor 6A-04 and I/O unit 6A-05.

The controller 6A-01 controls the overall operations of the UE in terms of mobile communication. For example, the controller 6A-01 receives/transmits signals through the transceiver 6A-03. In addition, the controller 6A-01 records and reads data in the storage unit 6A-02. To this end, the controller 6A-01 includes at least one processor. For example, the controller 6A-01 may include a communication processor (CP) that performs control for communication and an application processor (AP) that controls the upper layer, such as an application program. The controller controls storage unit and transceiver such that UE operations illustrated in the present disclosure are performed.

The storage unit 6A-02 stores data for operation of the UE, such as a basic program, an application program, and configuration information. The storage unit 6A-02 provides stored data at a request of the controller 6A-01.

The transceiver 6A-03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 6A-04 controls the overall operations other than mobile operation. The main processor 6A-04 process user input received from I/O unit 6A-05, stores data in the storage unit 6A-02, controls the controller 6A-01 for required mobile communication operations and forward user data to I/O unit 6A-05.

I/O unit 6A-05 consists of equipment for inputting user data and for outputting user data such as a microphone and a screen. I/O unit 6A-05 performs inputting and outputting user data based on the main processor's instruction.

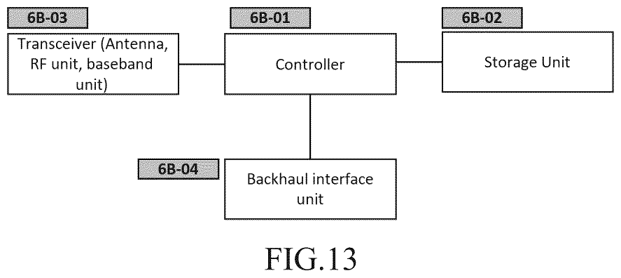

FIG. 13 is a block diagram illustrating the configuration of a base station according to the disclosure.

As illustrated in the diagram, the base station includes a controller 6B-01, a storage unit 6B-02, a transceiver 6B-03 and a backhaul interface unit 6B-04.

The controller 6B-01 controls the overall operations of the main base station. For example, the controller 6B-01 receives/transmits signals through the transceiver 6B-03, or through the backhaul interface unit 6B-04. In addition, the controller 6B-01 records and reads data in the storage unit 6B-02. To this end, the controller 6B-01 may include at least one processor. The controller controls transceiver, storage unit and backhaul interface such that base station operation illustrated in the present disclosure are performed.

The storage unit 6B-02 stores data for operation of the main base station, such as a basic program, an application program, and configuration information. Particularly, the storage unit 6B-02 may store information regarding a bearer allocated to an accessed UE, a measurement result reported from the accessed UE, and the like. In addition, the storage unit 6B-02 may store information serving as a criterion to determine whether to provide the UE with multi-connection or to discontinue the same. In addition, the storage unit 6B-02 provides stored data at a request of the controller 6B-01.

The transceiver 6B-03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 6B-04 provides an interface for communicating with other nodes inside the network. The backhaul interface unit 6B-04 converts a bit string transmitted from the base station to another node, for example, another base station or a core network, into a physical signal, and converts a physical signal received from the other node into a bit string.

What is claimed is:

1. A method performed by a terminal, the method comprising:
receiving from a base station a Radio Resource Control (RRC) reconfiguration message, wherein the RRC reconfiguration message comprises at least one candidate configuration, wherein each candidate configuration comprises:
a first identifier;
a second identifier; and
a set of configuration parameters;
receiving from the base station a specific Medium Access Control (MAC) Control Element (CE), wherein the MAC CE comprises:
the first identifier; and
a specific integer related to a first key-derivation-key;
in case that the second identifier associated with a serving cell is different from the second identifier determined from the first identifier indicated in the MAC CE:
deriving a second key-derivation-key based on a specific first key-derivation-key, wherein the specific first key-derivation-key is determined based on the specific integer in the MAC CE;
deriving a first encryption-key based on the second key-derivation-key;
configuring a specific set of Packet Data Convergence Protocol (PDCP) entities with the first encryption-key; and
reestablishing the specific set of PDCP entities.

2. The method of claim 1,
wherein the specific integer points to the specific first key-derivation-key in a specific set of first key-derivation-keys.

3. The method of claim 2,
wherein the second key-derivation-key is derived based on:
a specific bit stream; and
the first key-derivation-key.

4. The method of claim 3,
wherein the specific bit stream is generated based on cell identity of a specific cell and frequency channel number of the specific cell.

5. The method of claim 2,
wherein the specific first key-derivation-key associated with the specific integer is derived from a first key-derivation-key associated with the specific integer minus 1.

6. The method of claim 1,
wherein the specific set of PDCP entities consists of PDCP entities of a specific set of data radio bearers.

7. The method of claim 1, the method further comprising:
deriving a second encryption-key based on the second key-derivation-key;
configuring a second specific set of PDCP entities with the second encryption-key; and
discarding all Service Data Units (SDUs) and Protocol Data Units (PDUs) in the second specific set of PDCP entities.

8. The method of claim 7,
wherein the second specific set of PDCP entities consists of PDCP entities of a specific set of signaling radio bearers.

9. The method of claim 1, wherein:
prior to reestablishing the specific set of PDCP entities, the terminal resets header compression protocol based on a parameter related to header compression.

10. The method of claim 1,
wherein the set of configuration parameters comprises:
an embedded RRC reconfiguration message;
a parameter indicating physical cell identity of a special cell of a candidate configuration;
a parameter indicating that the embedded RRC reconfiguration message contains complete configuration; and
a parameter for configuring synchronization signals to be used for layer 1 measurement.

11. A terminal comprising:
a transceiver,
a memory, and
a controller coupled to the transceiver and the memory, wherein the controller is configured to cause the terminal to:
receive from a base station a Radio Resource Control (RRC) reconfiguration message, wherein the RRC reconfiguration message comprises at least one candidate configuration, wherein each candidate configuration comprises:
a first identifier;
a second identifier; and
a set of configuration parameters,
receive from the base station a specific Medium Access Control (MAC) Control Element (CE), wherein the MAC CE comprises:
the first identifier; and
a specific integer related to a first key-derivation-key;
in case that the second identifier associated with a serving cell is different from the second identifier determined from the first identifier indicated in the MAC CE:
derive a second key-derivation-key based on a specific first key-derivation-key, wherein the specific first key-derivation-key is determined based on the specific integer in the MAC CE;
derive a first encryption-key based on the second key-derivation-key;
configure a specific set of Packet Data Convergence Protocol (PDCP) entities with the first encryption-key; and
re-establish the specific set of PDCP entities.
